(19) United States
(12) Patent Application Publication
(10) Pub. No.: US 2026/0062093 A1
(43) Pub. Date: Mar. 5, 2026

(54) BATTERY HOLDER, MOBILE SUPPLY SYSTEM, AND MOBILE SUPPLY METHOD

(71) Applicant: HONDA MOTOR CO., LTD., Minato-ku, Tokyo (JP)

(72) Inventor: Yusuke OZAKI, Tokyo (JP)

(21) Appl. No.: 19/106,088

(22) PCT Filed: Aug. 24, 2023
(86) PCT No.: PCT/JP2023/030557

§ 371 Date: Feb. 24, 2025

(30) Foreign Application Priority Data
Sep. 29, 2022 (JP) 2022-157106

(51) Int. Cl. B62M 6/90; B62J 43/13; G08B 7/06; H01M 10/42; H01M 50/249

(52) U.S. Cl. CPC B62M 6/90; B62J 43/13; G08B 7/06; H01M 10/425; H01M 50/249; H01M 2010/4278

(57) ABSTRACT

[Problem]

To provide a battery holder, a mobile supply system, and a mobile supply method for providing at least one of mobile objects placed at a station to a user, which allow the user to easily recognize a location of the mobile object to be provided to the user.

[Solution]

A battery holder 36 for attaching a battery 7 to a mobile object 2, comprises a notification device 39 for providing a notification signal to outside of the battery holder when receiving a wireless signal that corresponds to the notification device.

### TECHNICAL FIELD

The present invention relates to a battery holder, a mobile supply system, and a mobile supply method for providing an electric-powered mobile object such as bicycles to be rented or shared, to a user wishing to use it.

### BACKGROUND ART

Patent Document 1 discloses a technology for enabling users to recognize the locations of unattended rental vehicles. In Patent Document 1, a rental vehicle is provided with a transmitter that emits a unique signal. A user having rented one carries a terminal capable of receiving the unique signal transmitted from the transmitter. The user recognizes a location of the rented vehicle based on whether or not the terminal carried by the user can effectively receive the unique signal by using a short-range communication scheme.

Patent Document 2 discloses a sharing system having a plurality of electric mobile vehicles each provided with one or more batteries for supplying power to the vehicle. When a user requests to use an electric mobile vehicle, the system acquires a remaining battery level or a maximum output power of a battery that the user can use. Then, based on the acquired remaining battery level or maximum output power, the system extracts information on an electric mobile vehicle that is available to the user, and provides the user with the information on the extracted electric mobile vehicle.

### PRIOR ART DOCUMENT(S)

### Patent Document(s)

Patent Document 1: JP2019-074930A
Patent Document 2: JP2022-083260A

### SUMMARY OF THE INVENTION

### Task to be Accomplished by the Invention

As taught in Patent Document 1 and Patent Document 2, rental and sharing services, in which a service provider accepts a request from a user and rents a mobile object to the user, have been widely available to the public. Such rental and sharing services are drawing attention as part of efforts to provide access to a sustainable transport system that also takes into consideration the needs of people who are vulnerable among transport users.

A user of such a service needs to go to a station where a plurality of mobile objects are placed, and find one to be rented to the user among the plurality of mobile vehicles. However, when mobile vehicles at the station cannot be easily seen such as at night, it is not easy for a user to recognize a location of a mobile vehicle to be used by the user.

The present invention has been made in view of the above-described problem of the prior art, and a primary object of the present invention is to provide a battery holder, a mobile supply system, and a mobile supply method for providing at least one of mobile objects placed at a station to a user which allow the user to easily recognize a location of the mobile object to be provided to the user.

### Means to Accomplish the Task

As a solution to the above-described tasks to be accomplished, an aspect of the present invention provides a battery holder (36) for attaching a battery (7) to a mobile object (2), the battery holder comprising: a notification (39) device configured such that, when a wireless signal corresponding to the notification device is transmitted, the notification device provides a notification signal to outside of the battery holder.

In this configuration, when a wireless signal corresponding to the notification device is transmitted, the notification device in the mobile object provides a notification signal to the outside, which allows a user to easily recognize the location of the mobile object to be provided.

The above battery holder may be further configured such that the battery is capable of transmitting the wireless signal.

This configuration allows a user to carry a battery and cause it to transmit a wireless signal, thereby recognizing the mobile object to be provided. This configuration also allows the user to move the mobile object using power from the battery.

The above battery holder may be further configured such that the battery holder further comprises a control device configured to receive the wireless signal, cause the notification device to operate based on the received wireless signal, and store an ID number of the mobile object, and wherein the control device compares the stored ID number with a received ID number contained in the received wireless signal, and when the stored ID number corresponds to the received ID number, the control device causes the notification device to operate.

This configuration enables a user to carry a battery and cause it to transmit a wireless signal, thereby causing the notification device in the corresponding mobile object to provide a notification signal to the outside, which allows the user to recognize the location of the corresponding mobile object.

As a solution to the above-described tasks to be accomplished, another aspect of the present invention provides a mobile supply system (1) for providing at least one of mobile objects (2) placed at a station (5) to a user, the mobile supply system comprising: a notification device (39, 43) provided in each of the mobile objects and capable of providing a notification signal to outside of the mobile object in which the notification device is provided; a terminal (7, 8) held by the user and capable of transmitting a wireless signal; and a control device (38) provided in the mobile object in which the notification device is provided and configured such that, when receiving the wireless signal, the control device causes the notification device in the same mobile object to provide the notification signal to the outside.

In this configuration, when a terminal held by a user transmits a wireless signal, the notification device in the mobile object to be used provides the notification signal to the user, and this notification signal allows the user to easily grasp the location of the mobile object to be used. Thus, this configuration provides a mobile supply system that allows a user to recognize the location of the mobile object to be used.

Preferably, the above supply system may be further configured such that the terminal transmits the wireless signal which includes ID information for identifying one of the mobile objects, and wherein, when receiving the wireless signal, the control device determines whether or not the ID information in the received wireless signal corresponds to the mobile object in which the control device is provided, and wherein, when determining that the ID information corresponds to the mobile object, the control device causes the notification device in the same mobile object to provide the notification signal to the outside.

In this configuration, use of a wireless signal including ID information allows a user to recognize the location of the corresponding mobile object.

Preferably, the above supply system may be further configured such that the mobile supply system further comprises a management server 10 configured to acquire reservation confirmation information that identifies a selected mobile object selected by the user from the mobile objects and transmits the reservation confirmation information to the terminal, wherein the terminal transmits the wireless signal with the reservation confirmation information included therein, wherein, when receiving the wireless signal from the terminal, the control device determines whether or not the mobile object in which the control device is provided is the selected mobile object, and wherein, when determining that the mobile object in which the control device is provided is the selected mobile object, the control device causes the notification device in the selected mobile object to provide the notification signal to the outside.

In this configuration, when a terminal held by a user transmits a wireless signal, the notification device in the mobile object selected by the user provides the notification signal. As a result, a user can easily grasp the location of the mobile object selected by the user in a station where a plurality of mobile objects are placed.

Preferably, the above supply system may be further configured such that the notification device includes a light-emitting device capable of emitting light to the outside of the mobile object, and wherein the notification device causes the light-emitting device to emit light, thereby providing the notification signal to the outside.

In this configuration, the notification device for providing a notification signal to a user can be made simple.

Preferably, the above supply system may be further configured such that the notification device includes a speaker capable of emitting a sound to the outside of the mobile object, and wherein the notification device causes the speaker to emit the sound, thereby providing the notification signal to the outside.

In this configuration, the notification device for providing a notification signal to a user can be made simple.

Preferably, the above supply system may be further configured such that the mobile object includes a body 12, a driving source 15 that causes movement of the body or assists the movement of the body, and a main battery 14 that supplies power to the driving source, and wherein, when receiving the wireless signal from the terminal, the control device acquires a remaining battery level of the main battery and causes the notification device to provide the notification signal to the outside according to the remaining battery level of the main battery.

In this configuration, a notification is made to a user according to a remaining battery level of the main battery, which improves usability of the mobile supply system.

Preferably, the above supply system may be further configured such that the notification device includes a plurality of light-emitting devices 39 capable of emitting light to thereby provide the notification signal to the outside of the mobile object, and

wherein the control device causes the notification device to change a number of light-emitting devices which are included in the plurality of light-emitting devices and emit light, thereby providing the notification signal to the outside according to the remaining battery level of the main battery.

This configuration allows a user to grasp a remaining battery level of the main battery based on the number of light-emitting devices that emit light, which improves usability of the mobile supply system.

Preferably, the above supply system may be further configured such that the notification device includes a light-emitting device capable of emitting light to the outside of the mobile object, and changing a color of the light emitted, and wherein the control device causes the notification device to change the color of the light emitted by the light-emitting device, thereby providing the notification signal to the outside according to the remaining battery level of the main battery.

This configuration allows a user to grasp a remaining battery level of the main battery based on the color of the light emitted by the light-emitting device, which improves usability of the mobile supply system.

Preferably, the above supply system may be further configured such that the mobile object includes a body 12, a driving source 15 that causes movement of the body or assists the movement of the body, and a main battery 14 that supplies power to the driving source, wherein the terminal includes a sub-battery capable of supplying power to the driving source, and wherein, when receiving the wireless signal from the terminal, the control device acquires a remaining battery level of the main battery and a remaining battery level of the sub-battery, and causes the notification device to provide the notification signal to the outside according to a sum of the remaining battery level of the main battery and the remaining battery level of the sub-battery.

In this configuration, a notification is made to a user according to the sum of the remaining battery level of the main battery and the remaining battery level of the sub-battery, enabling the user to easily grasp the amount of electric power that can be supplied to the driving source, which improves usability of the mobile supply system.

Preferably, the above supply system may be further configured such that the notification device includes a plurality of light-emitting devices 39 capable of emitting light to thereby provide the notification signal to the outside of the mobile object, and wherein the control device causes the notification device to change a number of light-emitting devices which are included in the plurality of light-emitting devices and emit light, thereby providing the notification signal to the outside according to the sum of the remaining battery level of the main battery and the remaining battery level of the sub-battery.

This configuration allows a user to grasp the amount of electric power that can be supplied to the driving source based on the number of light-emitting devices that emit light.

Preferably, the above supply system may be further configured such that the notification device includes a light-emitting device 39 capable of emitting light to the outside of the mobile object, and changing a color of the light emitted, and wherein the control device causes the notification device to change the color of the light emitted by the light-emitting device, thereby providing the notification signal to the outside according to the sum of the remaining battery level of the main battery and the remaining battery level of the sub-battery.

This configuration allows a user to grasp the amount of electric power that can be supplied to the driving source based on the color of the light emitted by the light-emitting device.

Preferably, the above supply system may be further configured such that the mobile supply system further comprises a management server 10 configured to acquire a planned travel distance, which is a distance to be traveled by the mobile object and planned by the user, wherein the management server acquires, based on the planned travel distance, a minimum battery level required for the movement or power-assistance in the movement of the mobile object for the planned travel distance, and notifies the control device of the minimum battery level, and wherein, when the sum of the remaining battery level of the main battery and the remaining battery level of the sub-battery is greater than or equal to the acquired minimum battery level, the control device causes the notification device to provide the notification signal to the outside.

This configuration allows a user to determine, based on the notification from the notification device, whether the sum of the remaining battery level of the main battery and the remaining battery level of the sub-battery is sufficient for the movement or power-assistance in the movement of the mobile object for the planned travel distance, which improves usability of the mobile supply system.

As a solution to the above-described tasks to be accomplished, yet another aspect of the present invention provides a mobile supply method for providing at least one of mobile objects (2) placed at a station (5) to a user, wherein a notification device is provided in each of the mobile objects, and capable of providing a notification signal to outside of the mobile object in which the notification device is provided, the method comprising the step of, when receiving a wireless signal transmitted from a terminal held by the user, causing the notification device to operate, thereby providing the notification signal to notify the user of a location of the mobile object to be provided to the user.

In this configuration, when a terminal held by a user transmits a wireless signal, the notification device in the mobile object to be used provides the notification signal to the user, and this notification signal allows the user to easily grasp the location of the mobile object to be used. Thus, this configuration provides a mobile supply method that allows a user to recognize the location of the mobile object to be used.

### Effect of the Invention

According to the above-described configurations, it is possible to provide a battery holder, a mobile supply system, and a mobile supply method for providing at least one of mobile objects placed at a station to a user which allow the user to easily recognize a location of the mobile object to be provided to the user.

### BRIEF DESCRIPTION OF THE DRAWINGS

FIG. 1 is a schematic diagram showing a general configuration of a sharing system provided with a mobile supply system according to a first embodiment of the present invention;

FIG. 2 is a side view of an electric bicycle, an example of an electric-powered mobile object;

FIG. 3 is a block diagram of the sharing system;

FIG. 4 is a side view of a sub-battery and a sub-battery holder for accommodating the sub-battery;

FIG. 5 includes (A) and (B), where (A) shows an example of a user database, and (B) shows an example of a mobile object database;

FIG. 6 includes (A) and (B), where (A) shows an example of a main battery database, and (B) shows an example of a station database;

FIG. 7 shows an example of a reservation start screen displayed on a terminal;

FIG. 8 shows an example of a user registration screen displayed on the terminal;

FIG. 9 shows an example of a reservation information entry screen displayed on the terminal;

FIG. 10 is a flowchart of a mobile supply operation;

FIG. 11 shows an example of an extracted information screen displayed on the terminal;

FIG. 12 includes (A) to (C), where (A) shows an example of a detailed information screen displayed on the terminal carried by a user who has a sub-battery, (B) shows an example of a detailed information screen displayed on the terminal carried by a user who does not have a sub-battery, and (C) shows an example of a detailed information screen displayed when a pop-up notification is made to a user who does not have a sub-battery;

FIG. 13 shows an example of a reservation confirmation screen displayed on the terminal;

FIG. 14 shows an example of an alert screen displayed on the terminal;

FIG. 15 is an example of a reservation start screen displayed on a terminal in a mobile supply system according to a second embodiment of the present invention;

FIG. 16 is an example of a search screen displayed on the terminal;

FIG. 17 is an example of a use details screen displayed on the terminal;

FIG. 18 includes (A) and (B), where (A) shows an example of a reservation information entry screen in which an entry field is formed with a pull-down menu that provides a list of options for a time of use, and (B) shows an example of a warning screen displayed when a time outside an available time period is entered in the entry field; and

FIG. 19 is a flowchart of a setting operation.

### DESCRIPTION OF THE PREFERRED EMBODIMENT(S)

Embodiments of a battery holder, a mobile supply system, and a mobile supply method according to the present invention will be described below with reference to the drawings.

### First Embodiment

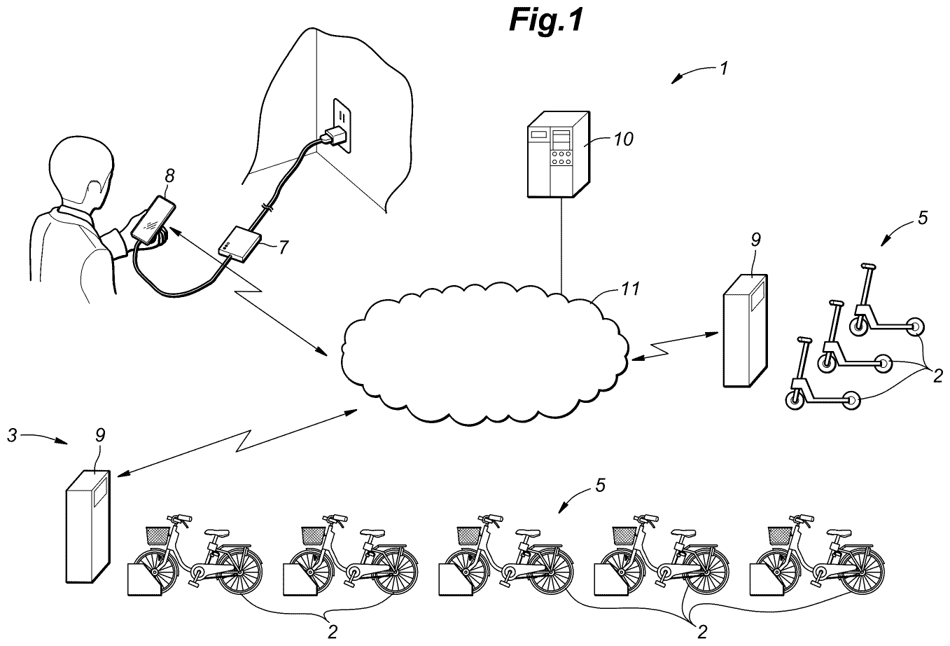

As shown in FIG. 1, a mobile supply system 1 is used to provide electric-powered mobile objects 2, which are to be rented and/or shared by a plurality of users, to users who wish to use it. The following description describes an example in which the mobile supply system 1 is used in a sharing system 3 (shared vehicle system) for sharing electric-powered mobile objects 2.

The electric-powered mobile objects 2 are placed at one or more stations 5 set up by a business operator that operates the sharing system 3. Through the mobile supply system 1, a user can make a request and rent an electric-powered mobile object 2 located at any of the stations 5. After use, the user returns the rented electric-powered mobile object 2 to the station 5.

The sharing system 3 includes a plurality of electric-powered mobile objects 2, sub-batteries 7 each distributed to a user who wishes to use it, terminals 8 each owned by a user, station servers 9 each located at a corresponding station 5, and a management server 10. The terminals 8, the station servers 9, and the management server 10 can communicate with each other via a public network such as the Internet 11. Each of the electric-powered mobile objects 2 has a mobile object ID, which is a unique ID number assigned thereto (i.e., identification information).

The following description describes an example in which electric-powered mobile objects 2 are electric bicycles. However, the electric-powered mobile objects 2 are not limited to electric bicycles. The electric-powered mobile object 2 may be any mobile object that is moved or power-assisted in the movement by electric power supplied from a battery provided therein, as well as electric bicycles. Examples of electric-powered mobile objects 2 include electric-powered kickboards, electric-powered wheelchairs, electric-powered carts, and robots.

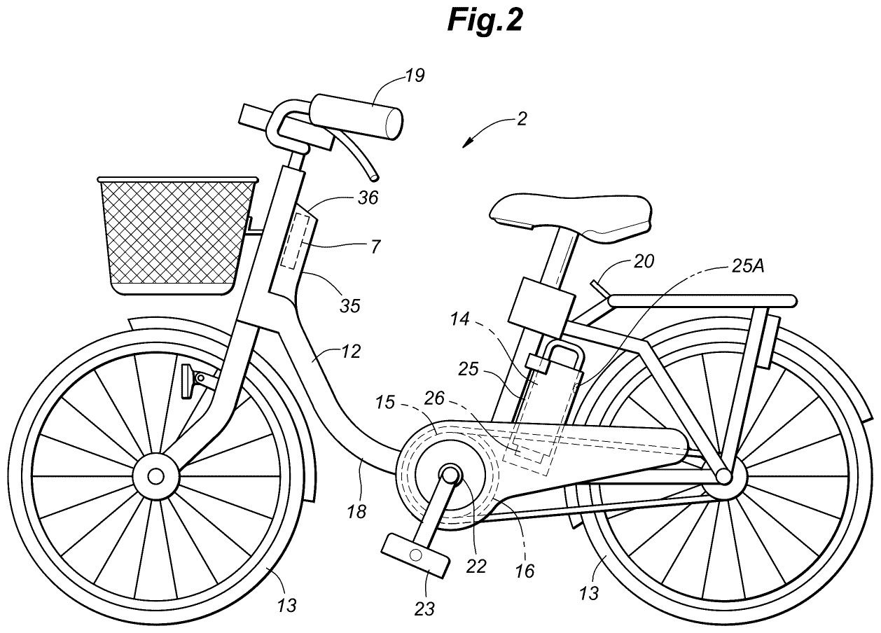

As shown in FIG. 2, the electric-powered mobile object 2 includes a vehicle body 12, wheels 13 mounted on the vehicle body 12, a main battery 14 provided in the vehicle body 12, a driving source 15 capable of operating by power from the main battery 14, and a drive control device 16 for controlling the operation of the driving source 15.

The vehicle body 12 serves as the body of the electric-powered mobile object 2. The vehicle body 12 includes a vehicle frame 18 and a steering wheel 19 for steering the wheels 13. A plate 20 indicating the mobile object ID is provided at the rear part of the vehicle frame 18 in order to enable a user having requested for use of the system to identify the electric-powered mobile object 2 to be provided to the user.

The vehicle frame 18 has a crank shaft 22 extending in a left-right direction. A pair of pedals 23 are attached to the ends of the crank shaft 22 on the left and right sides. When a user turns the pedals 23, the crank shaft 22 rotates.

The vehicle frame 18 is equipped with a main holder 25 for mounting the main battery 14. The main holder 25 has a main battery sensor 26 for calculating a remaining battery level of the main battery 14.

The driving source 15 is composed primarily of a motor. The driving source 15 is arranged near the crank shaft 22, and provides a rotational driving force, which is combined with a rotational force of the crank shaft 22 by a force combiner, and the combined force is transmitted to the wheels 13 (rear wheels) through chains.

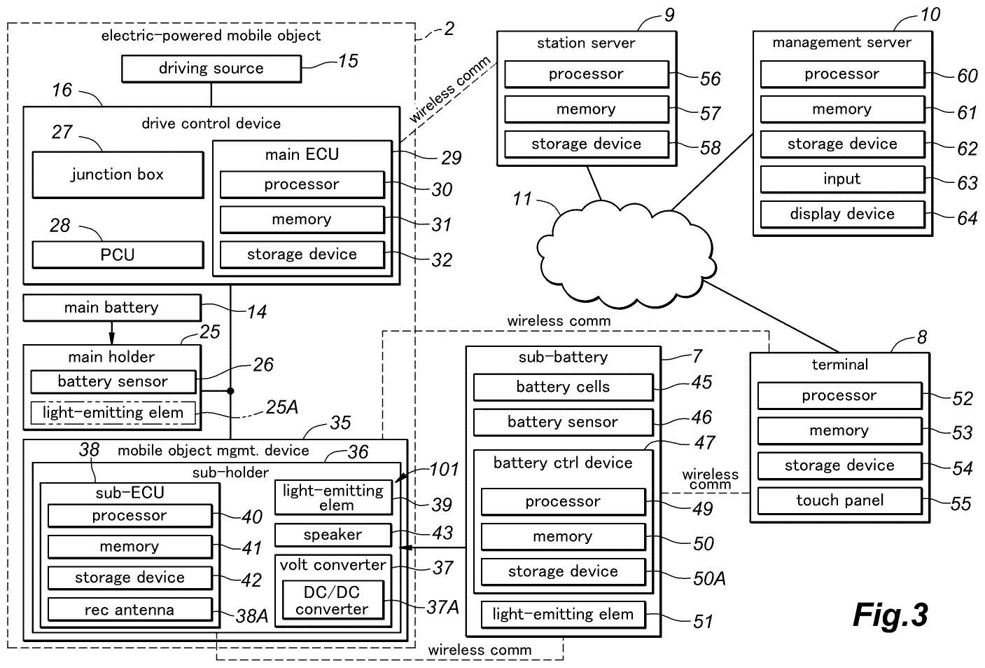

As shown in FIG. 3, the drive control device 16 includes a junction box 27 connected to the main battery 14 via a harness, a PCU 28 (power control unit) configured to convert a direct current supplied to the junction box 27 into an alternating current and supply the alternating current to the driving source 15, and a main ECU 29 (electronic control unit) for controlling the PCU 28.

The main ECU 29 includes a microcomputer provided with a processor 30 such as a central processing unit (CPU), a memory 31 such as RAM (Random Access Memory) and ROM (Read Only Memory), and a storage device 32 such as SSD (Solid State Drive) or HDD (Hard Disk Drive).

The main ECU 29 is connected to the main battery 14 and operates by power from the main battery 14. The main ECU 29 includes an antenna, and is capable of communicating with the station server(s) 9 via wireless communications. The storage device 32 (or the memory 31) of the main ECU 29 stores the mobile object ID of the electric-powered mobile object 2 to be provided.

The main ECU 29 controls the PCU 28, thereby controlling the supply of power from the main battery 14 to the driving source 15. When power is supplied to the driving source 15, the driving source 15 operates to generate a driving force, which is transmitted to the wheels 13 (rear wheels), which means that a user's pedaling on the pedals 23 is power-assisted by the driving force of the driving source 15, allowing the user to comfortably ride the electric-powered mobile object 2.

When the electric-powered mobile object 2 is an electric-powered kickboard, the pedals 23 are not provided, and the electric-powered mobile object 2 is driven by the battery-powered driving source 15. The electric-powered mobile object 2 is moved by power by the driving source 15, derived from battery power.

The main ECU 29 is connected to a main battery sensor 26 to acquire remaining battery levels of the main battery 14 at predetermined time intervals.

As shown in FIG. 2, the vehicle body 12 further includes a mobile object management device 35. As shown in FIG. 3, the mobile object management device 35 includes a sub-holder 36 coupled to the vehicle frame 18. The sub-holder 36 is a battery holder for attaching a sub-battery 7 to the electric-powered mobile object 2. The sub-holder 36 includes a voltage converter 37, a sub-ECU 38, and one or more light-emitting devices 39.

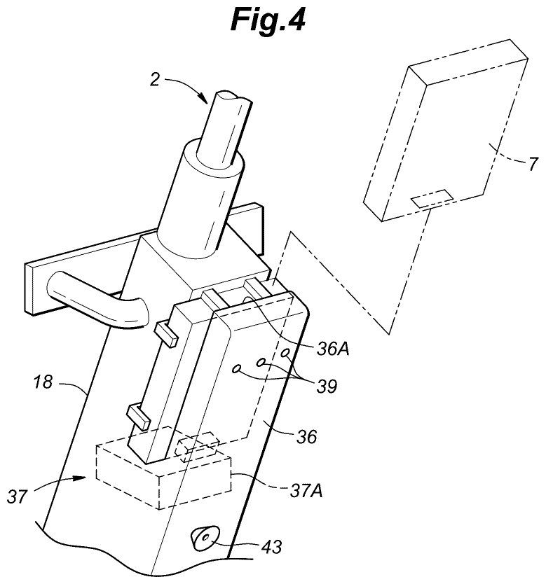

As shown in FIG. 4, the sub-holder 36 is coupled to the vehicle frame 18. The sub-holder 36 has a recess 36A that accommodates the sub-battery 7. When being accommodated in the recess 36A, the sub-battery 7 is supported by the electric-powered mobile object 2. In the present embodiment, the sub-battery 7 is configured to be removably provided in the recess 36A. This means that the sub-battery 7 is removable from the electric-powered mobile object 2.

The voltage converter 37 includes a DC/DC converter 37A that boosts the input voltage and outputs the boosted voltage. The input line of the DC/DC converter 37A is connected to the sub-battery 7 accommodated in the recess 36A, and the output line of the DC/DC converter 37A is connected to the junction box 27.

According to signals from the main ECU 29, the junction box 27 switches between the power lines from the main battery 14 and the sub-battery 7 connected to the driving source 15 or adjusts the distribution of power supplied to the driving source 15. This allows the driving source 15 to operate with power from both the main battery 14 and the sub-battery 7. In other words, the electric-powered mobile object 2 is moved or power-assisted in the movement by electric power supplied from the main battery 14 and the sub-battery 7. The sub-battery 7 functions to supply auxiliary power to the driving source 15 in substitution for the main battery 14.

The sub-ECU 38 is composed primarily of a microcomputer including a processor 40 such as a central processing unit (CPU), a memory 41 such as RAM (Random Access Memory) or ROM (Read Only Memory), and a storage device 42 such as SSD (Solid State Drive) or HDD (Hard Disk Drive).

The sub-ECU 38 is connected to the main battery 14 and preferably operates with power from the main battery 14. The sub-ECU 38 is equipped with a receiving antenna 38A (receiver) for receiving various radio signals (wireless signals), including short-range radio signals. The receiving antenna 38A receives radio signals, and outputs the received signals to the processor 40. The sub-ECU 38 may also be equipped with a transmit antenna for transmitting wireless signals.

The sub-ECU 38 and the main ECU 29 are capable of communicating with each other through wired or wireless communications. As a result, the sub-ECU 38 is allowed to communicate with the main ECU 29 to acquire information (e.g., mobile object ID) on the electric-powered mobile object 2 in which the sub-ECU 38 is provided, and then store the acquired information in a memory 41.

In the present embodiment, the sub-ECU 38 is comprised primarily of a microcomputer, but not limited to this configuration. For example, the sub-ECU 38 may also be configured with various drivers for controlling the one or more light-emitting devices 39. In addition, the sub-ECU 38 may be configured to operate by power from the sub-battery 7 in addition to power of the main battery 14.

As shown in FIG. 4, the one or more light-emitting devices 39 are provided on the sub-holder 36 and emit lights to outside of the object or a vehicle, thereby functioning as a notification device for providing a notification signal to a user. In the present embodiment, a plurality of light-emitting devices 39 are provided on the sub-holder 36. The sub-ECU 38 controls the light-emitting devices 39 by changing the number of light-emitting devices 39 that are emitting light and the color of the light emitted from the light-emitting devices 39. In other words, the sub-ECU 38 serves as a control device for the light-emitting devices 39 functioning as a notification device.

In the present embodiment, the electric-powered mobile object 2 is provided with light-emitting devices 39 functioning as a notification device. However, the configuration of the notification device may be limited to this. For example, the notification device may include a speaker 43 for generating sound. The sub-ECU 38 controls sound and a volume of the sound emitted from the speaker 43. In other words, the sub-ECU 38 serves as a control device for the speaker 43 functioning as a notification device. In this way, use of light-emitting devices 39 and/or a speaker 43 enables the notification device to be made simple, but properly provide a notification signal to a user.

The sub-battery 7 includes a plurality of battery cells 45. Each of the battery cells 45 is rechargeable and may be e.g., a lithium-ion cells. As shown in FIG. 1, the sub-battery 7 is configured to be rechargeable. The sub-battery 7 is preferably portable, i.e., capable of being carried by a user. The sub-battery 7 may also function as a battery capable of supplying power to various devices (also referred to as a user battery or mobile battery).

As shown in FIG. 3, the sub-battery 7 includes, in addition to the battery cells 45, a sub-battery sensor 46 for acquiring remaining battery levels of the battery cells 45 and a battery control device 47. The battery control device 47 is composed primarily of a microcomputer including a processor 40 such as a central processing unit (CPU), and a memory 50 such as RAM (Random Access Memory) and ROM (Read Only Memory). In other cases, the battery control device 47 may be equipped with a storage device 50A (not shown) such as SSD (Solid State Drive), or HDD (Hard Disk Drive). The battery control device 47 (i.e., the processor 49 in this case) is configured to acquire remaining battery levels of the battery cells 45 through the sub-battery sensor 46. The battery control device 47 and the terminal 8 may communicate with each other through short-range wireless communications. The battery control device 47 may also be configured to record and maintain a history of remaining battery levels of each of the battery cells 45, in the memory 50 or storage device 50A. In other cases, the battery control device 47 may be configured to be connectable to the network 11, and thus communicatively connected to various servers such as a station server 9 and a management server 10.

In the present embodiment, the battery control device 47 is configured with a microcomputer, but not limited to this configuration. Specifically, the battery control device 47 may be configured with various drivers for acquiring remaining battery levels of the battery cells 45. In some cases, the sub-battery 7 may also be provided with various notification devices such as a light-emitting device(s) 51 and a speaker.

The battery control device 47 is also capable of acquiring information on an electric-powered mobile object 2 to be provided to a user from the user's terminal 8, and storing the acquired information therein. The information on the electric-powered mobile object 2 includes a mobile object ID of the electric-powered mobile object 2 to be provided to the user. The battery control device 47 is also configured to communicate with the main ECU 29 and/or the sub-ECU 38. Specifically, for example, teg battery control device 47 (i.e., the sub-battery 7) is capable of transmitting a wireless signal including the mobile object ID to the sub-ECU 38.

The terminal 8 communicates with the sub-battery 7 (more specifically, the battery control device 47) to acquire a remaining battery level of the sub-battery 7 In other cases, the terminal 8 may be configured to communicate with the battery control device 47 to acquire sub-battery information, such as a charge history of the sub-battery 7.

The terminal 8 is comprised of e.g., a smartphone including a processor 52 such as a central processing unit (CPU), a memory 53, a storage 54, and a touch panel 55. The terminal 8 receives information on a request entered by a user who wishes to rent and/or share an electric-powered mobile object 2 and transmits the information to the management server 10. The terminal 8 is configured to generate a screen indicating information to the user and display the screen on the touch panel 55, the touch panel 55 being configured to receive the user's input. The terminal 8 and the sub-ECU 38 can communicate with each other through wireless signals using a short-range wireless communication standard. A distance over which communications are enabled between the terminal 8 and the sub-ECU 38 (a communication distance) is limited to within several meters to several tens of meters.

Each of the station servers 9 includes a computer provided with a processor 56 such as a central processing unit (CPU), a memory 57 such as RAM (Random Access Memory) and ROM (Read Only Memory), and a storage device 58 such as SSD (Solid State Drive) or HDD (Hard Disk Drive).

Each of the station servers 9 is configured to communicate wirelessly with the main ECUs 29 of electric-powered mobile objects 2 located at a corresponding station 5. The station server 9 acquires, for example, a remaining battery level of the main battery 14 detected by the main battery sensor 26 from each of the main ECU 29. The station server 9 transmits a remaining battery level of each of the main batteries 14 to the management server 10 via the network 11.

The management server 10 is used by an administrator of the sharing system 3. The management server 10 causes the terminal 8 to receive a user's request for use of the system and present candidates for the electric-powered mobile object 2 to be used. The management server 10 causes the terminal 8 to acquire the user's input for selection of the electric-powered mobile object 2. Furthermore, the management server 10 causes the terminal 8 to present information on the selected electric-powered mobile object 2, and performs operations for providing the selected electric-powered mobile object 2 to the user.

The management server 10 includes a computer provided with a processor 60 such as a central processing unit (CPU), a memory 61 such as RAM (Random Access Memory) and ROM (Read Only Memory), and a storage device 62 such as SSD (Solid State Drive) or HDD (Hard Disk Drive).

The management server 10 further includes an input device 63 for receiving inputs from the administrator, and a display device 64 for displaying and presenting information to the administrator. Examples of the input device 63 include a keyboard and a mouse, while examples of the display device 64 include a monitor.

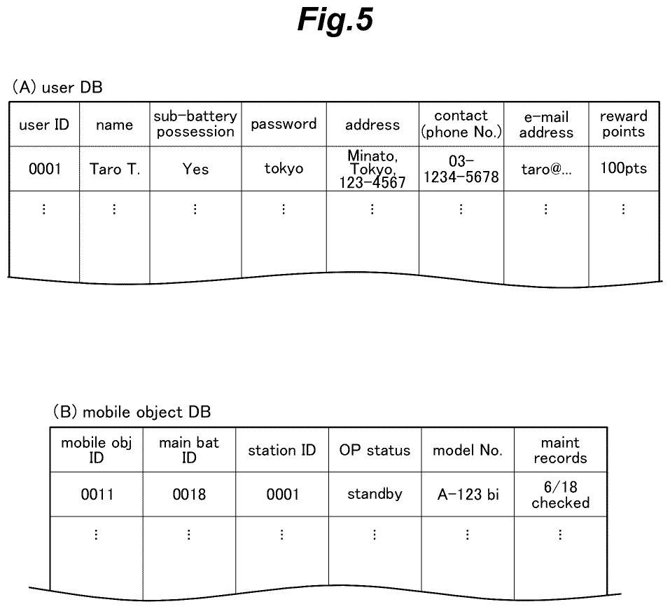

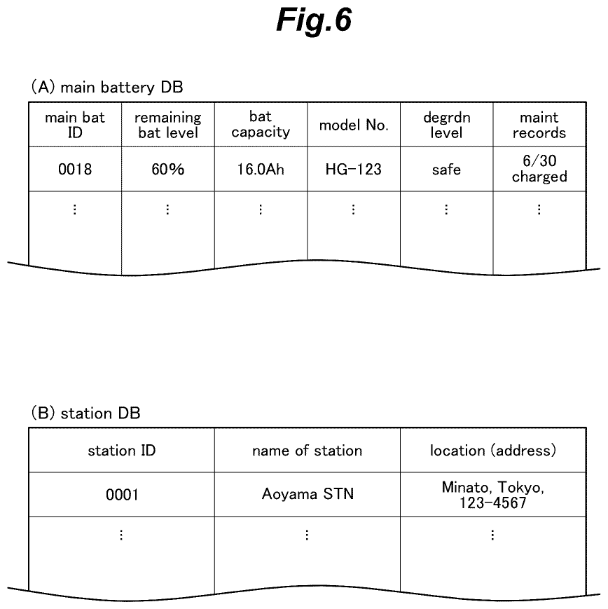

The storage device 62 of the management server 10 stores a user database (hereinafter referred to as “user DB”), a mobile object database (hereinafter referred to as “mobile object DB”), a main battery database (hereinafter referred to as “main battery DB”), and a station database (hereinafter referred to as “station DB”) (FIGS. 5 and 6).

The user DB contains information about users of the rental and/or sharing services of electric-powered mobile objects 2 (hereinafter also referred to as “user information”). The user information includes, for each user, the user's ID (hereinafter also referred to as simply “user ID”), the user's name, and possession status of a sub-battery (whether or not the user has a sub-battery). The user information may further include, for example, a user's encrypted password, address, contact information, e-mail address, and reward points the user has been given.

User information is acquired when the terminal 8 receives input from the user who is starting use of the mobile supply system 1. When acquiring the user information, the terminal 8 transmits the user information to the management server 10, and the processor 60 of the management server 10 stores the received user information in the user DB (also called the registrant DB) for registration of the user.

The mobile object DB contains information about the electric-powered mobile objects 2 (hereinafter referred to as “mobile object information”). The mobile object information includes, for each electric-powered mobile object 2, the mobile object ID, the ID of the main battery 14 attached to the electric-powered mobile object 2 of the mobile object ID (“main battery ID”), the ID of the station 5 where the electric-powered mobile object 2 is located (hereafter referred to as “station ID”), and the operating status (such as standby status, reserved status). The mobile object information may further include the type, model number, and maintenance history of each of the electric-powered mobile objects 2, which can include electric bicycles and electric-powered kickboards.

The mobile object ID, main battery ID, and station ID included in the mobile object information for each mobile object may be each entered by the administrator via the input device 63. The operation status included in the mobile object information is updated from time to time by the processor 60 of the management server 10.

The main battery DB contains information about the main battery 14 (hereinafter referred to as “main battery information”). The main battery information includes, for each main battery 14, the main battery ID and information associated with a remaining battery level (remaining battery level information). The main battery information may further include information on the capacity, model number, and degree of degradation, maintenance history (history of charging by the operator) of the main battery 14, and other information.

The processor 60 of the management server 10 is connected to each of the station servers 9 via the network 11. The management server 10 acquires the mobile object ID and a remaining battery level of the main battery 14 of the electric-powered mobile object 2 from the station server 9 every predetermined time. For each electric-powered mobile object 2, the processor 60 of the management server 10 refers to the mobile object DB, extracts the corresponding main battery ID, and updates the remaining battery level information associated with the main battery ID, with the acquired remaining battery level.

The station DB contains information about each of the stations 5 (hereinafter referred to as “station information”). The station information includes, for each station 5, the station ID, station name, and location (address, residence).

Next, a process from when a user makes a reservation to when the user starts using an electric-powered mobile object 2 will be described.

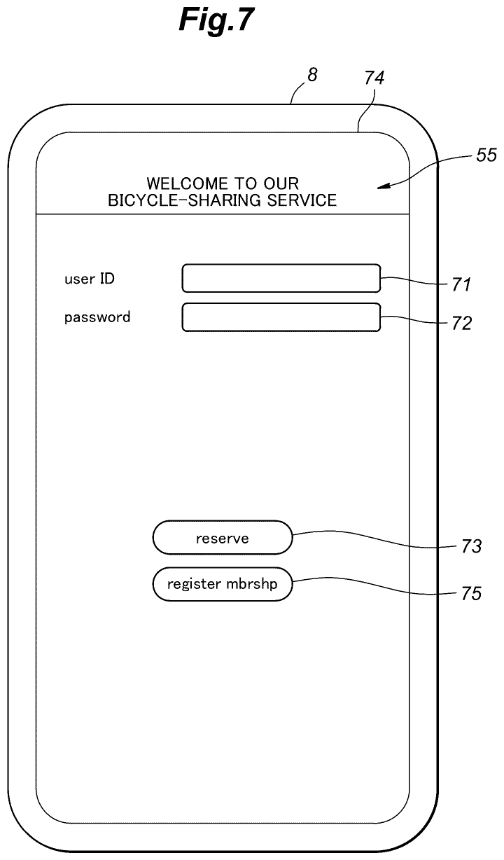

A user who wishes to use an electric-powered mobile object 2 installs a prescribed application onto the user's terminal 8 and opens the application. Once the application is opened up, a reservation start screen 74 is displayed on the terminal 8, as shown in FIG. 7. The reservation start screen 74 includes a user ID entry field 71, a password entry field 72, and a reservation start button 73. The reservation start screen 74 may include a member registration button 75 for users who have not yet registered, and other buttons.

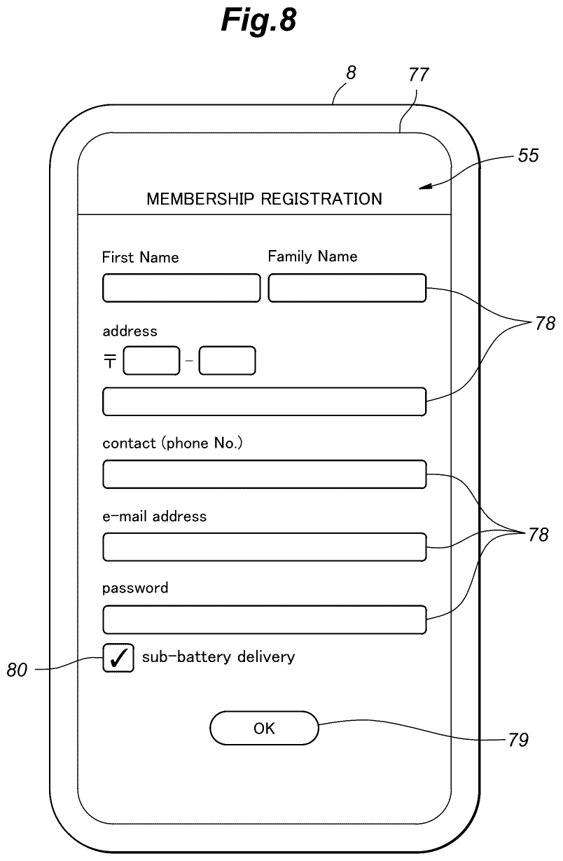

When the user touches the member registration button 75, the terminal 8 displays a registration screen 77 as shown in FIG. 8. The registration screen includes entry fields 78 for entry of user information such as name, address, contact information, e-mail address, telephone number, and password, as well as a completion button 79. The registration screen 77 may include a sub-battery delivery Y/N checkbox 80 to enter whether the user wishes to receive (use) the sub-battery 7.

When the user touches the completion button 79, the terminal 8 transmits registration information including the entered address, contact information, e-mail address, telephone number, and password to the management server 10. When the management server 10 receives the registration information, the processor 60 of the management server 10 associates the user ID with the registration information and stores the received information to the user DB, thereby performing member registration.

The administrator can check the delivery Y/N checkbox 80 as necessary, in order to deliver a sub-battery 7 to a user carrying the terminal 8 from which the registration information has been transmitted.

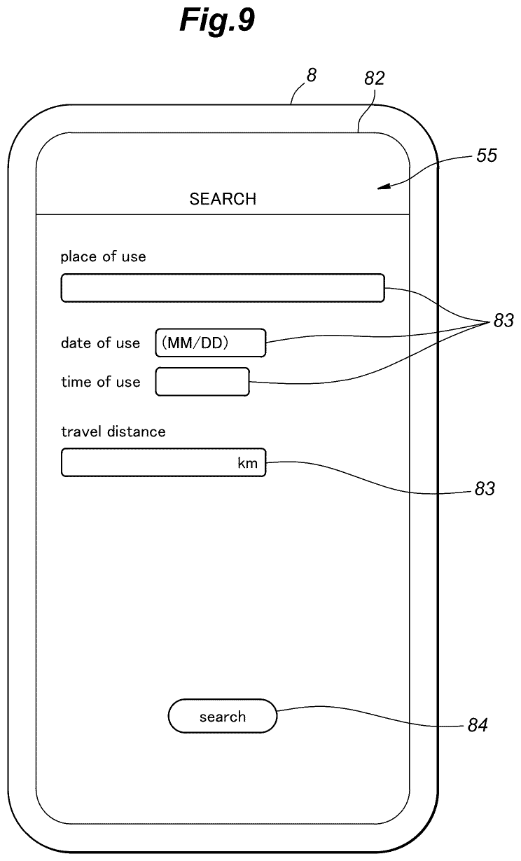

When the user enters the user ID, e-mail address, and other information and then touches the reservation start button 73 in the reservation start screen 74, the terminal 8 displays a reservation information entry screen 82 as shown in FIG. 9. The reservation information entry screen 82 includes a search button 84, and entry fields 83 for entry of place of use, date of use, time of use, and distance of use.

When the user enters a place, date, time, and distance of use and then touches the search button 84, the terminal 8 transmits the reservation information including the place, date, time, and distance of use along with the user ID to the management server 10.

When the management server 10 receives the reservation information, the processor 60 of the management server 10 executes a prescribe computer program (hereinafter referred to as “mobile object provision program”), thereby performing the mobile supply operation for providing a mobile object, where the mobile supply operation involves extracting a mobile object(s) suitable for the user based on the user's request, presenting the extracted mobile object(s), and providing a mobile object to be provided. More specifically, in the mobile supply operation, the processor 60 performs the following operations: referring to the user DB, the mobile object DB, and the main battery DB based on the user's required (i.e., reservation information) to set extraction conditions, and extracting electric-powered mobile objects 2 suitable for the user's request, and presenting the extracted mobile objects to the user.

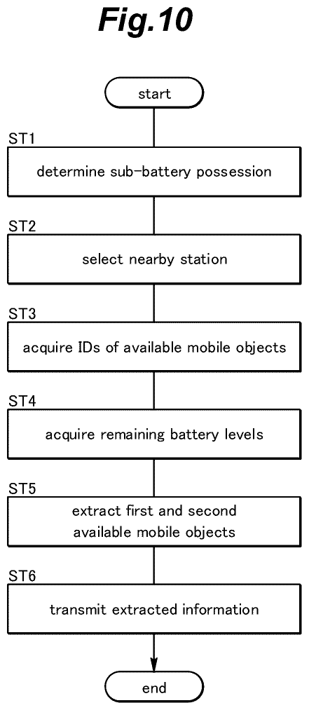

Next, details of the mobile supply operation will be described with reference to FIG. 10. In the mobile supply operation, the processor 60 of the management server 10 first acquires ID of a user (i.e., user ID) from the user's reservation information. Then, the processor 60 of the management server 10 refers to the user DB to determine the user's possession status of a sub-battery 7 (ST1).

Next, the processor 60 of the management server 10 acquires information about the place of use from the reservation information. The processor 60 of the management server 10 then refers to the station DB to acquire a station(s) 5 near the place of use from the existing stations 5 (ST2).

The processor 60 of the management server 10 then acquires the station ID of each of the acquired stations 5 and then refers to the mobile object DB thereof to find one or more electric-powered mobile objects 2 which will be available in the requested time of use at the station 5 (hereinafter also referred to as “available mobile object”), and acquire the mobile object IDs of the available mobile objects (ST3).

Next, by using the mobile object IDs of the available mobile objects, the processor 60 of the management server 10 refers to the mobile object DB, acquires the main battery ID associated with each of the available mobile objects, and then by referring to the main battery DB, acquires a remaining battery level of the corresponding main battery 14 installed therein (ST4).

Next, the processor 60 of the management server 10 extracts, from among the available mobile objects, an available mobile object(s) where the remaining battery level of the main battery 14 provided therein is equal to or greater than a first threshold value as a first available mobile object, and also extracts an available mobile object(s) where the remaining battery level of the main battery 14 provided therein is equal to or greater than a second threshold value as a second available mobile object. (ST5). In other words, these two conditions that the remaining battery level of the main battery 14 is equal to or greater than the first threshold value, and that the remaining battery level is equal to or greater than the second threshold value, correspond to extraction conditions.

The processor 60 of the management server 10 then transmits extracted information to the terminal 8, the extracted information including a result of the determination of as to whether the user requesting for use of the system has a sub-battery 7, information on each of the first available mobile objects (i.e., the mobile object ID, the station ID of the station 5 in which the first available mobile object is placed, and the remaining battery level), information on each of the second available mobile object (i.e., the mobile object ID, the station ID of the station 5 in which the second available mobile object is placed, and the remaining battery level) (ST6).

In this operation, the management server 10 refers to the station DB to thereby acquire the station ID of each of the stations 5 where either the first available mobile object or the second available mobile object is placed (hereinafter referred to as the “available stations”), and transmits the acquired station IDs of the available stations together with the corresponding location information to the terminal 8.

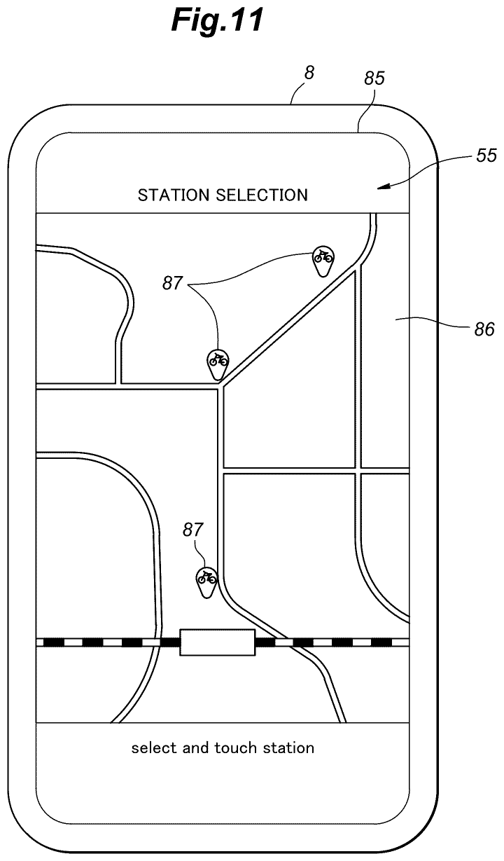

When receiving the extracted information, the terminal 8 uses the extracted information to generate and display a extracted information screen 85 as shown in FIG. 11.

Specifically, the processor 52 in the terminal 8 first acquires, from the extracted information, the result of the determination as to whether the user requesting for use of the system has a sub-battery 7.

When the user has a sub-battery 7, the processor 52 of the terminal 8, based on the information on the second available mobile objects and the information on the available stations, acquires the locations of the available stations in which one or more second available mobile objects are placed, as well as the number of those second available mobile objects. The processor 52 of the terminal 8 then generates an extracted information screen 85 including icons 87 overlaid on a map 86, each of the icons 87 indicating the location of a corresponding station 5 where one or more second available mobile objects are available, along with the number of second available mobile objects there.

When the user does not have a sub-battery 7, the processor 52 of the terminal 8, based on the information on the first available mobile objects and the information on the available stations, acquires the locations of the available stations in which one or more first available mobile objects are placed, as well as the number of the one or more first available mobile objects. The processor 52 of the terminal 8 then generates the extracted information screen 85 including the icons 87 overlaid on the map 86, each of the icons 87 indicating the location of a corresponding station 5 where one or more first available mobile objects are available, along with the number of those first available mobile objects there.

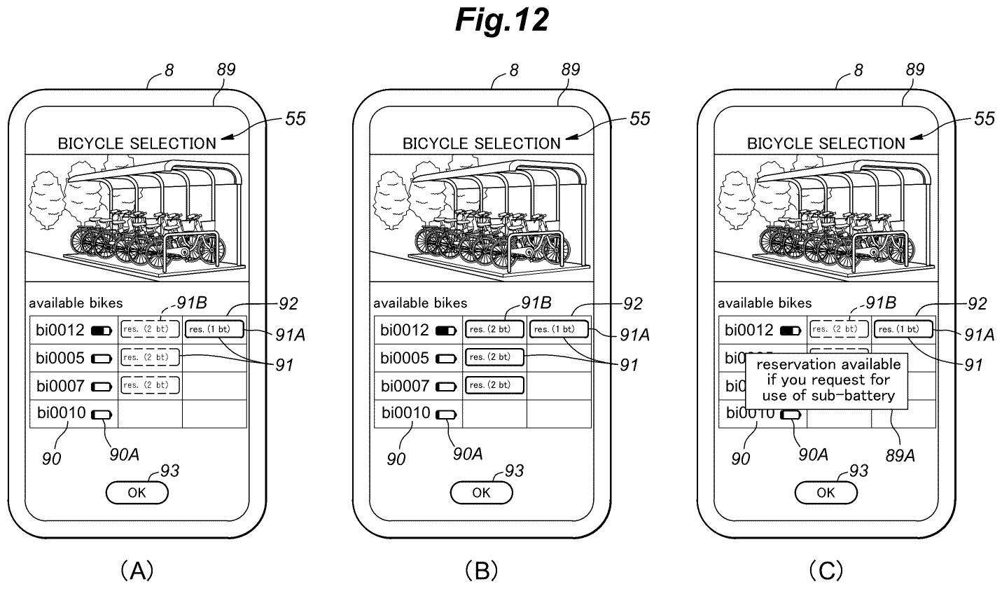

When the user touches one of the icons 87 on the extracted information screen 85, the processor 52 in the terminal 8 generates a detailed information screen 89 and displays the generated screen on the touch panel 55, as shown in FIGS. 12(A) and 12(B).

The detailed information screen 89 shows a list 92 (table) indicating information on the station 5 corresponding to the touched icon 87, in which list the mobile object IDs of the first available mobile object and the second available mobile object located there, and corresponding select buttons 91, each having a text 90 indicating the type of available mobile object (first and/or second), are shown in the form of a table. The detailed information screen 89 includes an OK button 93 as well as the list 92.

Moreover, when the user requesting for use of the system does not have a sub-battery 7, the processor 52 of the terminal 8 generates the detailed information screen 89, as shown in FIG. 12(A), which allows for use of the select buttons 91A for the first available mobile objects, but does not allow for use of any of the select buttons 91B for the second available mobile objects. Thus, the detailed information screen 89 allows the user to select only the first available mobile objects. In other words, a user who does not have a sub-battery 7 is not allowed to select any of the electric-powered mobile objects 2 which is not included in the first available mobile objects, and included only in the second available mobile objects in the list.

In such a case, the detailed information screen 89 preferably displays the select buttons 91B for the second available mobile objects in the non-selectable state. This enables a user who does not have a sub-battery 7 to be notified that a user having a sub-battery 7 can have a broader scope of selectable electric-powered mobile objects 2. When a user having a sub-battery 7 selects one of the select buttons 91B for the second available mobile objects, the terminal 8 may also display a notification that a remaining battery level of the sub-battery 7 is checked.

Preferably, as shown in FIGS. 12(A) and 12(B), the detailed information screen 89 includes icons 90A and/or numerical values indicating remaining battery levels of the main batteries 14 of the respective available mobile objects. The terminal 8 may also be configured to communicate with the battery control device 47 of a sub-battery 7 to acquire the remaining battery level of the sub-battery 7 thereof, and display the detailed information screen 89 including an icon and/or numerical value indicating the remaining battery levels of the sub-battery 7.

When a user requesting for use of the system has a sub-battery 7, the processor 52 of the terminal 8 generates the detailed information screen 89, as shown in FIG. 12(B), which allows for use of both the select buttons 91A and 91B for the first and second available mobile objects. Thus, the detailed information screen 89 allows the user to select both the first and second available mobile objects. In other words, a user having a sub-battery 7 is allowed to select any of the second available mobile objects in the list. Since the first threshold is greater than the second threshold, a set of first available mobile objects is included in a set of second available mobile objects.

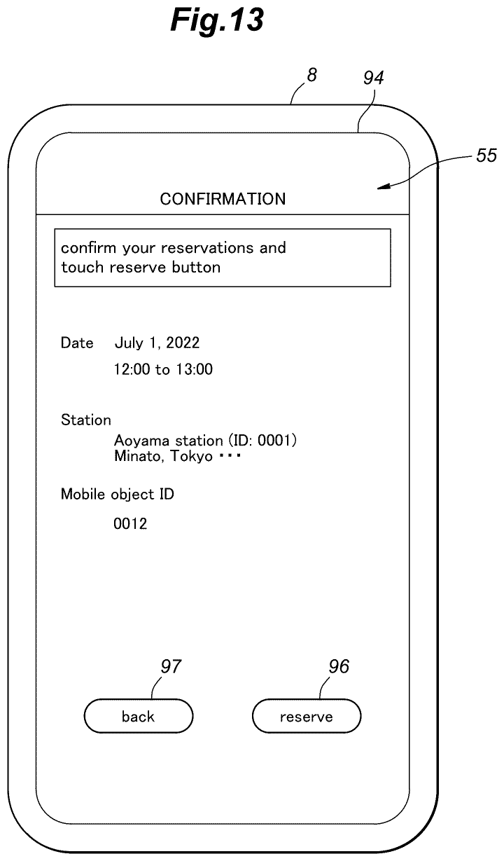

When the user selects an electric-powered mobile object 2 that the user wishes to use and touches an OK button on the detailed information screen 89, the terminal 8 displays a reservation confirmation screen 94 as shown in FIG. 13.

The reservation confirmation screen 94 shows a reservation date and time, the mobile object ID of the electric-powered mobile object 2 that the user wishes to use, a name of the station where the selected electric-powered mobile object 2 is located and the corresponding station ID, and a reservation button 96. In the present embodiment, the reservation confirmation screen 94 has a back button 97 for modifying the reservation.

When the reservation button 96 on the reservation confirmation screen 94 is touched, the terminal 8 transmits the reservation confirmation information to the management server 10, the reservation confirmation information including the reservation date and time, the mobile object ID of the electric-powered mobile object 2 that the user wishes to use, the name of the station where the selected electric-powered mobile object 2 is located, and the corresponding station ID.

Upon receiving the reservation confirmation information, the management server 10 acquires the station ID from the reservation confirmation information and transmits the reservation confirmation information to the station server 9 provided at the station 5 having the station ID.

Upon receiving the reservation confirmation information, the station server 9 transmits the reservation confirmation information to the main ECU 29 of the selected mobile object. When receiving the reservation confirmation information, the main ECU 29 transmits the reservation confirmation information to the sub-ECU 38.

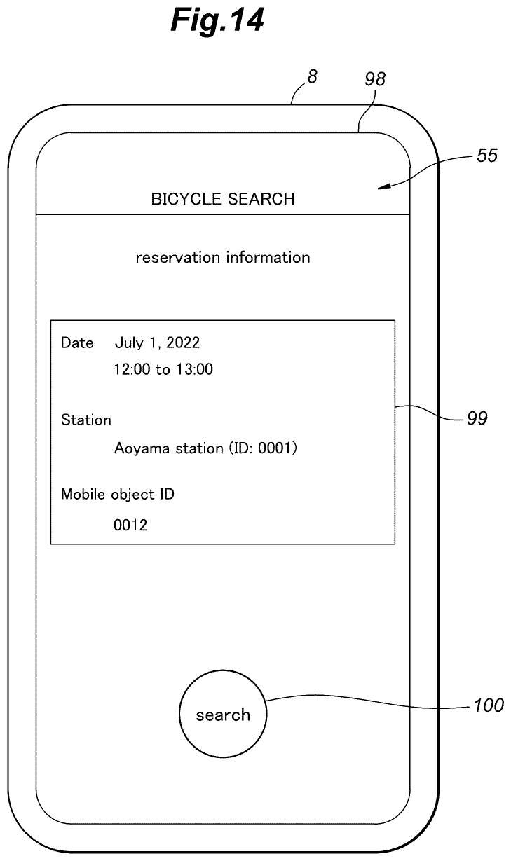

The management server 10 transmits an alert signal including the reservation confirmation information to the terminal 8 that made the corresponding reservation a predetermined time before the date and time of use. When the terminal 8 receives the alert signal, the processor 52 of terminal 8 displays an alert screen 98 on touch panel 55, as shown in FIG. 14. alert screen 98 includes a reservation confirmation information section 99 showing the reservation confirmation information and a search button 100.

When the user moves to the station 5 where the reserved electric-powered mobile object 2 is located based on the information displayed on the alert screen 98 and touches the search button 100, the terminal 8 transmits a search signal including the mobile object ID (i.e., ID information that identifies the electric-powered mobile object 2) to the outside. The search signal is a wireless signal using a short-range wireless communication standard, and is used for communications between the terminal 8 and the sub-ECU 38. The range of the search signal is limited to a few tens of meters from the terminal 8.

When receiving the search signal, the sub-ECU 38 acquires the mobile object ID from the search signal. The sub-ECU 38 then communicates with the main ECU 29 to acquire the mobile object ID of the electric-powered mobile object 2 in which the main ECU is installed. The sub-ECU 38 then determines whether the mobile object ID included in the search signal matches the mobile object ID of the electric-powered mobile object 2 in which the main ECU and the sub-ECU 38 are provided. When determining that a match is achieved; that is, when the mobile object ID in the ID information contained in the search signal identifies the electric-powered mobile object, the sub-ECU 38 (the processor 40) blinks the light-emitting device(s) 39 on the electric-powered mobile object 2 in which the sub-ECU 38 is installed.

In other cases, the battery control device 47 may use the mobile object ID of the mobile object provided to the user to generate and transmit a search signal containing that mobile object ID. In this case, the sub-ECU 38 compares the mobile object ID of the search signal transmitted by the battery control device 47 with the mobile object ID of the electric-powered mobile object 2 in which the sub-ECU is provided. When both the mobile object IDs correspond to each other (in the present embodiment, when a match is achieved), the sub-ECU 38 blinks the light-emitting device(s) 39.

When a plurality of light-emitting devices 39 are provided, the processor 40 of the sub-ECU 38 may be configured to acquire a remaining battery level of the main battery 14 from the main ECU 29 and blinks a certain number of light-emitting devices, which are included in the plurality of light-emitting devices, with the number of the blinking light-emitting devices being changed according to the remaining battery level of the main battery 14. In other embodiments, when the color of the light emitted by the light-emitting device(s) 39 can be changed, the processor 40 of the sub-ECU 38 may change the color of the light emitted by the light-emitting device(s) 39 (the emission color of the light-emitting device 39) according to the remaining battery level of the main battery 14. In this case, when the remaining battery level of the main battery 14 is sufficient, the processor 40 of the sub-ECU 38 sets the emission color of the light-emitting device(s) 39 to green, while when the remaining battery level of the main battery 14 is not sufficient, the processor 40 of the sub-ECU 38 may set the light-emitting device(s) 39 to emit red or yellow light. This configuration allows a user to easily grasp a remaining battery level of the main battery 14 based on the number of blinking light-emitting devices 39 or based on the color of the light emitted by the light-emitting device(s), which improves usability of the mobile supply system 1.

In other embodiments, the processor 40 of the sub-ECU 38 may be configured to acquire a remaining battery level of the main battery 14 from the battery control device 47 and blink a certain number of light-emitting devices with the number of the blinking light-emitting devices being changed according to a sum of the remaining battery levels of the main battery 14 and the sub-battery 7. In other embodiments, when the color of the light emitted by the light-emitting device(s) 39 can be changed, the processor 40 of the sub-ECU 38 may change the color of the light emitted by the light-emitting device(s) 39 (the emission color of the light-emitting device 39) according to the sum of the remaining battery levels of the main battery 14 and the sub-battery 7. This configuration allows a user to grasp a sum of the remaining battery levels of the main battery 14 and the sub-battery 7 that can supply (i.e., provide) power to the driving source 15 based on the number and color of the light-emitting devices 39 that emit light.

Furthermore, when a user's planned travel distance, which is a distance to be traveled by the mobile object and planned by the user, is included in the reservation confirmation information, the processor 40 of the sub-ECU 38 calculates, based on the planned travel distance, a minimum battery level required for the movement or power-assistance in the movement of the electric-powered mobile object 2 for the planned travel distance, and then, based on a difference between the sum of the remaining battery levels of the main battery 14 and the sub-battery 7 and the calculated minimum battery level, the processor 40 changes the number of light-emitting devices that emit light or the color of the light emitted from the light-emitting device. This configuration allows a user, based on the number of light-emitting devices that emit light or the color of the light emitted from the light-emitting device, to grasp whether a sum of the remaining battery levels of the main battery 14 and the sub-battery 7 is sufficient for the movement or power-assistance in the movement of the electric-powered mobile object 2 for the user's planned travel distance.

The electric-powered mobile object 2 may be provided with a speaker 43 as a notification device. In this case, when the mobile object ID included in the search signal matches that of the electric-powered mobile object 2 in which the sub-ECU 38 is provided, the processor 40 of the sub-ECU 38 may produce sound from the speaker 43 to provide a notification signal to a user. In other embodiments, the main holder 25 that holds the main battery 14 may also be provided with a light-emitting device(s) 25A. In this case, when receiving a search signal, the main ECU 29 may cause the light-emitting device(s) 25A provided in the main holder 25 (FIG. 2) to emit light. The main ECU 29 may set the characteristics or manner of light emission, such as the emission color of the light-emitting device, based on the remaining battery level of the main battery 14.

In this way, a notification system 101 for providing a notification signal to the user of the reserved electric-powered mobile object 2, is configured with the sub-ECU 38 and the notification device (e.g., the light-emitting devices 39 in the sub-holder 36, the light-emitting device(s) 25A in the main holder 25, the speaker 43), which is provided in the electric-powered mobile object 2 and capable of providing the notification signal to the outside thereof.

When finding the reserved electric-powered mobile object 2, the user starts using it as appropriate. When finishing the use of the rental mobile object, the user returns the electric-powered mobile object 2 to the station 5 and operates the terminal 8 to notify the management server 10 that the user has finished using it. When receiving the notification from the terminal 8, the management server 10 charges the user for the service and calculates reward points corresponding to the time of use. The management server 10 stores data of the calculated reward points to the user DB, thereby granting reward points to the user. The user can use the granted reward points to pay for another use of the electric-powered mobile object 2, pay for purchases or other purposes.

Next, main effects achieved by the so configured mobile supply system 1 will be described.

The management server 10 acquires a request from a user and extracts a station(s) 5 that is close to a place of use. Among mobile objects located at the station 5 that is closest to the extracted place of use. the management server 10 selects a mobile object(s) in which the remaining battery level is equal to or greater than a first threshold value as a first available mobile object(s), and also selects a mobile object(s) in which the remaining battery level is equal to or greater than a second threshold value as a second available mobile object(s). Then, as shown in FIGS. 12(A) and (B), the terminal 8 presents the first available mobile object and the second available mobile object selected by the management server 10 to the user.

As shown in FIG. 5(A), the management server 10 holds information as to each user's possession status of a sub-battery 7 in the user DB. For each of the users having sub-batteries 7, the user's terminal 8 displays the select button(s) 91A corresponding to the first available mobile object(s) and the select button(s) 91B corresponding to the second available mobile object(s) on the detailed information screen 89.

For each of the users having no sub-batteries 7, the user's terminal 8 generates the detailed information screen 89, as shown in FIG. 12(A), which allows for use of the select button(s) 91A for the first available mobile object(s), but does not allow for use of any of the select button(s) 91B for the second available mobile object(s).

This configuration may be considered that each of the users' terminals 8 displays electric-powered mobile objects 2 which are selectable to the user; that is, electric-powered mobile objects 2 in which their main batteries 14 have remaining battery levels that are equal to or greater than a lower limit of the remaining battery level set as a threshold level, where the threshold level is determined to be a first threshold for users having no sub-batteries 7 and the threshold level is determined to be a second threshold smaller than the first threshold for users having their sub-batteries 7.

As shown in FIG. 12(A), the detailed information screen 89 allows users having no sub-batteries 7 to select electric-powered mobile objects 2 in which the main batteries 14 have remaining battery levels that are equal to or greater than the first threshold, whereas. as shown in FIG. 12(B), the detailed information screen 89 allows users having their sub-batteries 7 to select electric-powered mobile objects 2 in which the main batteries 14 have remaining battery levels that are equal to or greater than the second threshold. As the first threshold is greater than the second threshold, the users having no sub-batteries 7 have a limited number of selectable electric-powered mobile objects 2 compared to the users having their sub-batteries 7. In this way, this configuration using different thresholds presents the detailed information screen 89 that enables users having no sub-batteries 7 to know that a user having a sub-battery 7 can have a broader scope of selectable electric-powered mobile objects 2 compared to those having no sub-batteries 7. This allows users having no sub-batterie 7 to be motivated to own their sub-batteries 7. This configuration also can provide an incentive (which is also referred to as a reward, privilege, or advantage) to users having their sub-batteries 7.

The detailed information screen 89 presented to users having no sub-batteries 7 may include a notice (such as an advertisement or introduction) that induces the user to own a sub-battery 7. Specifically, as shown in FIG. 12(C), the detailed information screen 89 presented to users having no sub-batteries 7 includes lightly displayed select buttons 91B for the second available mobile objects. In some cases, when any of those select buttons 91B is touched, a pop-up 89A may be displayed informing the user that more electric-powered mobile objects 2 will become available for selection when the user requests for use of a sub-battery 7.

As described above, the number of selectable electric-powered mobile objects 2 available for users having their sub-batteries 7 is equal to or greater than that for users having no sub-batteries 7. This allows users having no sub-batterie 7 to be motivated to own their sub-batteries 7, and can provide an incentive (a reward, privilege, or advantage) to users having their sub-batteries 7, resulting in an increase in the number of users having sub-batteries 7 and a decrease in the main batteries 14 having remaining battery levels that are below the threshold levels. The remaining battery levels of the main batteries 14 are less likely to drop, which can reduce costs of recharging main batteries 14 and other maintenance costs therefor. Furthermore, the fact that the remaining battery levels of the main batteries 14 are less likely to drop results in a decrease in electric-powered mobile objects 2 that remain at the stations 5; that is, encourages the use of the electric-powered mobile objects 2.

When a search signal, which is a wireless signal, is transmitted from a terminal 8 carried by a user, the light-emitting devices 39 provided in the reserved electric-powered mobile object 2 to be used emit light to provide a notification signal to the user. In other words, the present invention provides a mobile supply method for providing an electric-powered mobile object 2 to a user, the method comprising, upon receiving a signal from a terminal 8 carried by the user, causing a notification device (such as light-emitting devices 39, or a speaker 43) provided in each of the mobile objects to provide a notification signal that notifies the user of the location of the electric-powered mobile object 2 to be provided to the user. The notification signal allows the user to easily recognize the location of the electric-powered mobile object 2 reserved by the user.

In the present embodiment, the sub-battery 7 is also capable of transmitting a search signal. Thus, when a user requests for use of a sub-battery 7 and carries the sub-battery 7, this configuration allows the light-emitting devices 39 in the reserved electric-powered mobile object 2 to be used to emit light, providing a notification signal to the user. The notification signal allows the user to easily recognize the location of the electric-powered mobile object 2 reserved by the user. Thus, in addition to supplying power to the electric-powered mobile object 2, the sub-battery 7 can be used to transmit wireless signals to cause the notification device to provide a notification signal notifying the user of the location of the reserved electric-powered mobile object 2. As this configuration encourages the use of the sub-batteries 7, the remaining battery levels of the main batteries 14 are less likely to drop, thereby reducing costs required for maintenance of electric-powered mobile objects 2.

### Second Embodiment

The mobile supply system 1 according to a second embodiment has the same physical configuration as the mobile supply system 1 of the first embodiment. The mobile supply system 1 of the second embodiment is different from the first embodiment in the operations performed by the main ECU 29, the sub-ECU 38, the processor 52 of a terminal 8, the processor 60 of management server 10, and the processor 56 of the station server 9.

Specifically, the mobile supply system 1 of the first embodiment is configured such that only users who made reservations are allowed to use the electric-powered mobile object 2. However, the mobile supply system 1 of the second embodiment is configured such that users who have not made reservations are also allowed to rent an electric-powered mobile object 2 at a station 5.

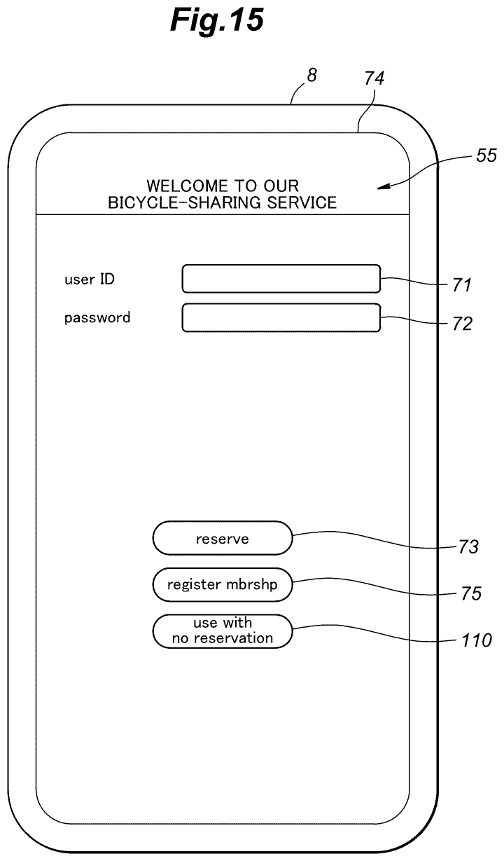

In the second embodiment, as shown in FIG. 15, the reservation start screen 74 includes a no reservation button 110 for users who wish to use the service without making reservations, as well as the user ID entry field 71, the password entry field 72, the reservation start button 73, and the member registration button 75.

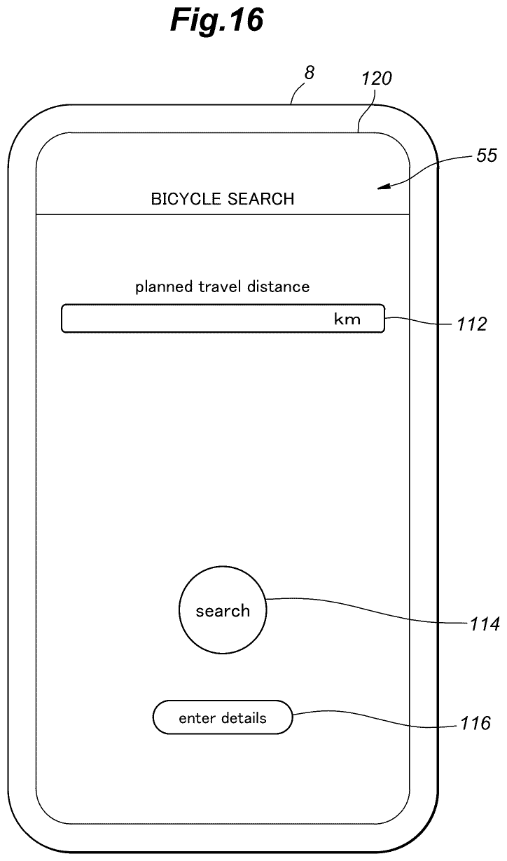

When no reservation button 110 is touched, as shown in FIG. 16, the terminal 8 displays a search screen 120 that includes an entry field 112 for entry of a planned travel distance, a search button 114, and a detail entry button 116.

At a station 5 where the user is to rent an electric-powered mobile object 2, when a user touches the search button 114 on the search screen 120 without entry in the entry field 112 for entry of a planned travel distance, the terminal 8 transmits a search signal that does not include either a mobile object ID or a planned travel distance. When a user enters a planned travel distance in the entry field 112 and touches the search button 114 on the search screen 120, the terminal 8 transmits a search signal that does not contain a mobile object ID, but contains only the entered planned travel distance.

When the sub-ECU 38 receives a search signal, the processor 40 of the sub-ECU 38 determines whether or not the search signal includes a mobile object ID. When the search signal includes a mobile object ID, the processor 40 of the sub-ECU 38 determines whether the mobile object ID included in the search signal matches the mobile object ID of the electric-powered mobile object 2 in which the main ECU and the sub-ECU 38 are provided in the same manner as the first embodiment. When determining that a match is achieved, the processor 40 of the sub-ECU 38 blinks the light-emitting device(s) 39 on the electric-powered mobile object 2 in which the sub-ECU38 is installed.

When the search signal does not include a mobile object ID, the processor 40 of the sub-ECU 38 determines whether or not the search signal includes a planned travel distance. When determining that the search signal does not include a planned travel distance, the processor 40 of the sub-ECU 38 acquires the remaining battery level of the main battery 14 from the main ECU 29. When the remaining battery level is above a predetermined threshold, the sub-ECU 38 blinks the light-emitting device(s) 39 on the electric-powered mobile object 2 in which the sub-ECU 38 is installed.

When the search signal includes a mobile object ID, the processor 40 of the sub-ECU 38 calculates, based on the planned travel distance, a minimum battery level required for the movement or power-assistance in the movement of the electric-powered mobile object 2 for the planned travel distance. Then, the processor 40 of the sub-ECU 38 acquires the remaining battery level of the main battery 14 from the main ECU 29, and when the remaining battery level is above the calculated minimum battery level, the sub-ECU 38 blinks the light-emitting device(s) 39 on the electric-powered mobile object 2 in which the sub-ECU 38 is installed.

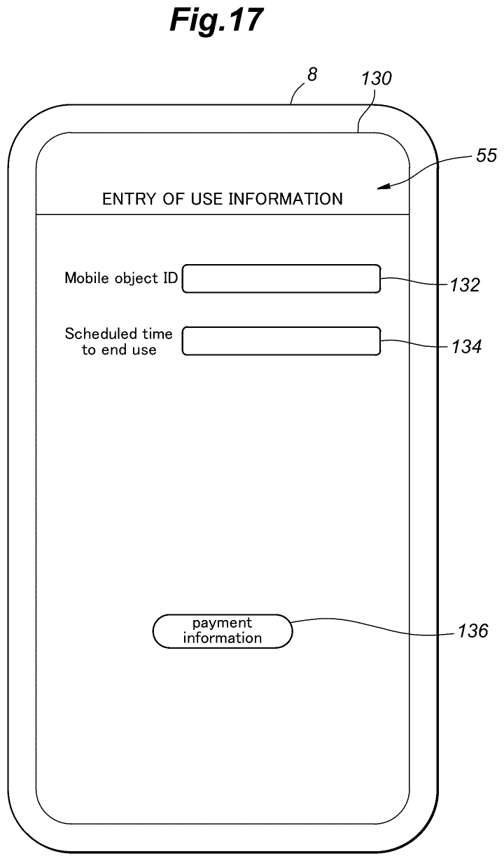

Then, after determining the electric-powered mobile object 2 to be used, the user touches the detail entry button 116. Upon detecting the user's touch on the detail entry button 116, the terminal 8 displays the use details screen 130, as shown in FIG. 17. The use details screen 130 may include an entry field 132 for entry of the mobile object ID used by the user, as well as an entry field 134 for entry of a scheduled time to end use, and a payment information entry button 136. In some cases, the entry field 132 for entry of a mobile object ID may be configured such that, when a user images the plate 20 (or a code on the plate) on the vehicle body 12, the mobile object ID in the image is automatically entered. After completing the entry of the mobile object ID and the scheduled end time of use, the user touches the payment information entry button 136. The terminal 8 then displays an entry screen (not shown) for entering payment information, and once the user has entered the user's payment information, the electric-powered mobile object 2 can be used.

Next, effects achieved by the so configured mobile supply system 1 will be described. In the second embodiment, even when a user has not made a reservation for use, the mobile supply system 1 allows the user to use the electric-powered mobile object 2 by going to a station 5 and completing the necessary procedures, which improves usability of the mobile supply system 1 compared to the system of the first embodiment.

In the present embodiment, when a search signal includes a planned travel distance, the processor 40 of the sub-ECU 38 calculates a minimum battery level required for the movement or power-assistance in the movement of the electric-powered mobile object 2 for the planned travel distance, and when the sum of the remaining battery levels of the main battery 14 and the sub-battery 7 is above the calculated minimum battery level, the light-emitting device(s) 39 blinks.

Based on the blinking of the light-emitting device(s) 39, the user can see whether a sum of the remaining battery levels of the main battery 14 and the sub-battery 7 is sufficient for the movement or power-assistance in the movement of the electric-powered mobile object 2 for the user's planned travel distance. This configuration allows the user to select an electric-powered mobile object 2 that can supply to the driving source 15 the amount of power required for the movement for the planned travel distance, thereby improving usability of the mobile supply system 1.

### Third Embodiment

The mobile supply system 1 according to a third embodiment is the same as the first embodiment except that the system of the present embodiment differs from the first embodiment in the operations of step ST5 and step ST6 in the mobile supply operation performed by the management server 10 and the operations to generate extracted information screen 85 and detailed information screen 89 performed by the terminal 8. Thus, the description of the same features as the first embodiment will not be repeated here.

In step ST5 of the mobile supply operation, the processor 60 of the management server 10 extracts all electric-powered mobile objects 2 which will be available in a requested time of use at a station(s) 5 nearby a place of use (“available mobile objects”). Upon completion of the extraction, the processor 60 of the management server 10 transmits extracted information to the terminal 8, the extracted information including the mobile object IDs of the extracted electric-powered mobile object 2, the station ID of the station(s) 5, remaining battery levels of the main batteries 14 of the extracted electric-powered mobile object 2. In the present embodiment, the management server 10 transmits the extracted information along with an entered planned travel distance to the terminal 8.

Upon receiving the extracted information, the processor 52 of the terminal 8 communicates with the battery control device 47 of the sub-battery 7 to acquire the remaining battery level of the sub-battery 7. The processor 52 of the terminal 8 determines and sets first and second threshold values. The first threshold value is set to a predetermined value as in the first embodiment. However, the second threshold value is determined based on the remaining battery level of the sub-battery 7.

Specifically, the processor 52 of the terminal 8 determines the second threshold value such that the second threshold value is equal to or less than the first threshold value and set to become a smaller value as the remaining battery level of the sub-battery 7 increases. In the present embodiment, the processor 52 of the terminal 8 calculates, based on the planned travel distance, an amount of power required for the movement or power-assistance in the movement of the electric-powered mobile object 2 for the planned travel distance, and subtract the remaining battery level of the sub-battery 7 from the calculated amount of power to thereby determine the second threshold value.

Next, the processor 52 of the terminal 8 acquires, from the extracted information, an electric-powered mobile object(s) 2 where the remaining battery level of the main battery 14 therein is equal to or greater than the first threshold value as a first available mobile object. Furthermore, the processor 52 of the terminal 8 acquires, from the extracted information, an electric-powered mobile object(s) 2 where the remaining battery level of the main battery 14 therein is equal to or greater than the second threshold value as a second t available mobile object.

Then, as in the first embodiment, when the user has a sub-battery 7, the processor 52 of the terminal 8 generates an extracted information screen 85 including icons 87 overlaid on the map 86, each of the icons 87 indicating the location of a corresponding station 5 where one or more second available mobile objects are available, along with the number of second available mobile objects there. When the user does not have a sub-battery 7, as in the first embodiment, the processor 52 of the terminal 8 generates an extracted information screen 85 including icons 87 overlaid on the map 86, each of the icons 87 indicating the location of a corresponding station 5 where one or more first available mobile objects are available, along with the number of first available mobile objects there.

Next, effects achieved by the so configured mobile supply system 1 will be described. In the system of the second embodiment, the second threshold is determined based on the remaining battery level of the sub-battery 7. Specifically, the second threshold is determined by subtracting the remaining battery level of the main battery 14 from the amount of electric power required for the movement or power-assistance in the movement of the electric-powered mobile object 2 for the planned travel distance.

The system configured such that the first and second thresholds are determined as described above, allows the electric-powered mobile object 2 that is reserved for a user having a sub-battery 7 to be selected from the second available mobile objects in each of which a sum of the remaining battery levels of the main battery 14 and the sub-battery 7 is greater than the amount of electric power required for the movement or power-assistance in the movement of the electric-powered mobile object 2 for the planned travel distance. Thus, in the configuration, for an electric-powered mobile object 2 that is reserved for a user having a sub-battery 7, the total battery level of the batteries in the electric-powered mobile object 2 are prevented from being run out during the movement or power-assistance in the movement of the electric-powered mobile object 2 for the planned travel distance.

### Fourth Embodiment

The mobile supply system 1 according to a fourth embodiment is the same as the first embodiment except that, in the system of the present embodiment, the terminal 8 sets a time period during which a user is allowed to request use of the service based on the user's possession status of a sub-battery 7. Thus, the description of the same features as the first embodiment will not be repeated here.

After the terminal 8 displays the reservation start screen 74 (FIG. 7), when a requesting user (i.e., a user who has made a reservation for use of the service) touches the reservation start button 73, the terminal 8 transmits, to the management server 10, requesting user's ID information including the user ID of the requesting user and a password. The management server 10 then refers to the user DB and transmits information on whether or not the requesting user's possession status of a sub-battery 7 (also referred to as battery possession information) to the terminal 8.

Based on the received battery possession information, the terminal 8 determines a time period within which the user is allowed to enter a time of use in the entry field 83 in the reservation information entry screen 82, (hereinafter also referred to as “available time period”), such that the available time period is restricted to a time period from an start time when the reservation information entry screen 82 is opened (or when the entry is made) to a time that is a predetermined period of time ahead of the start time. Thus, the terminal 8 places a restriction on entry in the entry field 83 for entry of a time of use, thereby allowing a user to enter a request for use of the service within a time period from the time of entry to a time that is a predetermined period of time ahead of the time of entry.

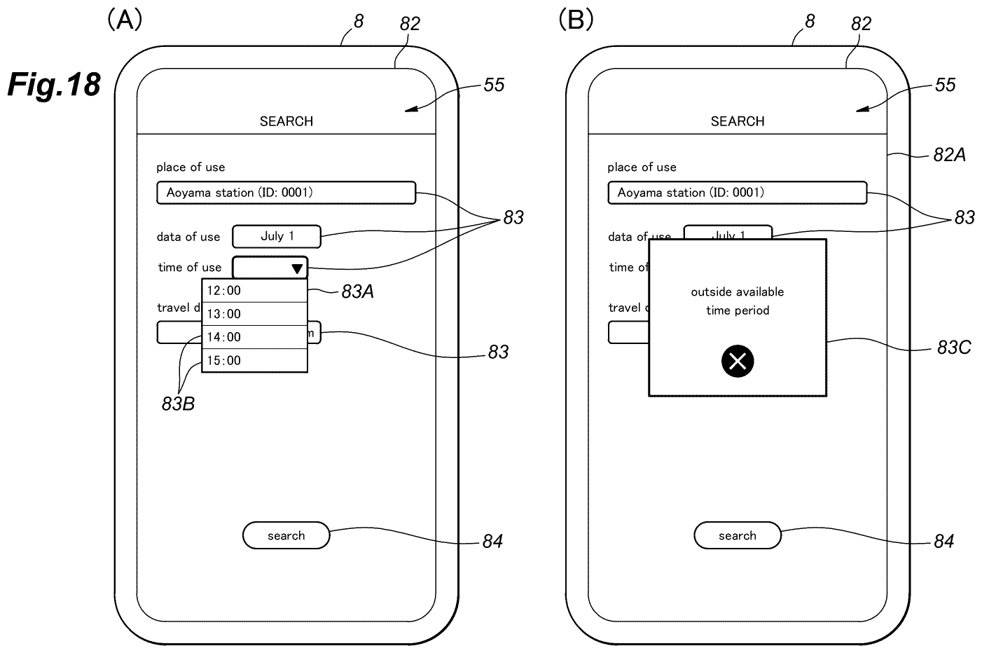

As shown in FIG. 18(A), the terminal 8 (the processor 52) may form the entry field 83 with a pull-down menu 83A that provides a list of options for a time of use, all of which fall within an available time period (a time period from a time of receiving the requesting user's ID information to a time that is a certain time-slot length ahead of the time of receiving), thereby achieving the restriction on the time period during which a user can enter a request for use of the service. FIG. 18(A) shows an example in which the start time at which the reservation information entry screen 82 was opened is 12:00, and an time-slot length is three (3) hours from the start time.

In other embodiments, the terminal 8 may form the entry field 83 which allows for direct entry of input elements such as numbers that represent a time of use. In this case, when numbers or other elements entered in the entry field 83 represent a time period outside the available time period, the terminal 8 may generate and display a warning screen 82A with a popup 83C indicating that the entered time of use represented by numbers or other elements is outside the available time period on the touch panel 55 as shown in FIG. 18(B).

However, the terminal 8 sets a longer time slot length for users having their sub-batteries 7 compared to that for users having no sub-batteries 7. In other words, the terminal 8 sets a longer available time period for users having their sub-batteries 7 than that for users having no sub-batteries 7.

For example, the terminal 8 may determine the available time period such that users having their sub-batteries 7 have an available time period from seven days before to a time of use to be entered, while users having no sub-batteries 7 have an available time period from three days before to a time of use to be entered. This means that users having no sub-batteries 7 are allowed to reserve use of an electric-powered mobile object 2 three days before a time of use to be reserved, while users having their sub-batteries 7 are allowed to reserve use of an electric-powered mobile object 2 seven days before a time of use to be reserved.

In other cases, the terminal 8 may determine the available time period such that users having their sub-batteries 7 have an available time period from seven hours before to a time of use to be entered, while users having no sub-batteries 7 have an available time period from three hours before to a time of use to be entered. This means that users having no sub-batteries 7 are allowed to reserve use of an electric-powered mobile object 2 three hours before a time of use to be reserved, while users having their sub-batteries 7 are allowed to reserve use of an electric-powered mobile object 2 seven hours before a time of use to be reserved.

In this way, the terminal 8 determines an available time period, during which a user can reserve use of the service, such that the available time period starts earlier by the difference in the time slot length depending on whether the user has a sub-battery 7 or not. When an available time period is set to be a time period from an entry time when a time of use to be reserved is entered to seven hours ahead of the entry time, users are allowed to reserve use of the service seven hours before the time of use to be reserved, and the length of time of seven hours corresponds to the time slot length.

The system may be configured such that the terminal 8 sets a time slot length for each of the electric-powered mobile objects 2. The terminal 8 may shorten the time slot length as the remaining battery level of the main battery 14 decreases. The terminal 8 may also set the time slot length to be shorter as the percentage of the remaining battery level of the main battery 14, which is calculated by dividing the remaining battery level of the main battery 14 by the fully charged battery level, becomes smaller. Specifically, the terminal 8 may set the time slot length to satisfy the following equation:

$$Y = ( 100 - A ) \times α$$

where Y is a time slot length, A is the percentage of the remaining battery level, and a is an arbitrary positive constant.

Thus, when the terminal 8 sets the time slot length according to the remaining battery level of the main battery 14, the terminal 8 may acquire information on an available mobile object, and generate the extracted information screen 85 and the detailed information screen 89 based on the remaining battery level of the main battery 14 of the available mobile object in the same manner as in the third embodiment. For example, the processor 52 of the terminal 8 may set the time slot length based on the remaining battery level of the main battery 14, and then determine whether each of the select buttons 91 in the detailed information screen 89 is selectable or not based on a date of use and a time of use entered in the reservation information entry screen 82 and a time when the reservation information entry screen 82 was opened.

Next, effects achieved by the so configured mobile supply system 1 will be described. In this embodiment, the terminal 8 determines the available time period for a user based on whether the user has a sub-battery 7 or not. Specifically, the terminal 8 sets a longer available time period for users having their sub-batteries 7 than for users having no sub-batteries 7. This configuration allows users having their sub-batteries 7 to reserve use of an electric-powered mobile object 2 earlier than users having no sub-batteries 7, thereby providing an incentive to users having their sub-batteries 7. The provision of incentive to the owners of sub-batteries 7 encourages the use of the sub-batteries 7, resulting in a decrease in electric-powered mobile objects 2 that remain at the stations 5.

### Fifth Embodiment

The mobile supply system 1 according to a fifth embodiment is the same as the first embodiment except that the system of the present embodiment includes two or more types of mobile objects, and in step ST5 in the mobile supply operation performed by the management server 10. Thus, the description of the same features as the first embodiment will not be repeated here.

In the present embodiment, a mobile supply system 1 includes two types of electric-powered mobile objects 2. One type of electric-powered mobile object 2 (“Type A”) is lighter and easier to speed up than the other type of electric-powered mobile object 2 (“Type B”). For example, Type A may be a cross bike type bicycle and Type B may be a city bike type bicycle. Type A may also be mobile objects other than bicycles (e.g., electric-powered mobile objects 2 other than bicycles, such as electric wheelchairs).

In step ST5 of the mobile supply operation, the processor 60 of the management server 10 extracts, from available mobile objects, only electric-powered mobile objects 2 of Type B as first available mobile objects, and both electric-powered mobile objects 2 of Type A and electric-powered mobile objects 2 of Type B as second available mobile objects.

Next, effects achieved by the so configured mobile supply system 1 will be described.

When a requesting user does not have a sub-battery 7, the processor 52 of the terminal 8 makes only the first available mobile objects available for selection in the detailed information screen 89. This allows users having no sub-batteries 7 to reserve only electric-powered mobile objects 2 of Type B. When a requesting user has a sub-battery 7, the processor 52 of the terminal 8 makes both first and second available mobile objects available for selection in the detailed information screen 89. This allows users having their sub-batteries 7 to reserve both electric-powered mobile objects 2 of Type A and those of Type B.

As a result, a scope of selectable electric-powered mobile objects 2 is set to be broader than that for users having their sub-batteries 7 than for users having their sub-batteries 7. Thus, this configuration encourages users having their sub-batteries 7 to use the electric-powered mobile objects 2.

### Sixth Embodiment

The mobile supply system 1 according to a sixth embodiment is the same as the first embodiment except that, in the system of this embodiment, the battery control device 47 is configured to acquire a usage history of the sub-battery 7, and the management server 10 gives reward points to a user based on the user's usage history. Thus, the description of the same features as the first embodiment will not be repeated here.

The battery control device 47 of a sub-battery 7 acquires a usage status of the sub-battery 7 based on the rate of decrease in the remaining battery level of the sub-battery 7. For example, when the remaining battery level of the sub-battery 7 is above a predetermined threshold, the battery control device 47 determines that the sub-battery 7 is being used and counts usage time.

The battery control device 47 is configured to be connected to the mobile object management device 35 when the sub-battery 7 is attached to the sub-holder 36. When detecting that is connected to the mobile object management device 35, the battery control device 47 determines that the sub-battery 7 is being used for the movement or power-assistance in the movement of the electric-powered mobile object 2, and does not count usage time.

The battery control device 47 transmits a usage report signal including the usage time, to the terminal 8 via wireless communications each time the date changes. Upon receiving the usage report signal, the terminal 8 transmits to the management server 10. When receiving the usage report signal, the management server 10, based on the usage time, gives reward points to the user of the sub-battery 7 each time the date changes. In other cases, the management server 10 may make the user's available time for reservation start earlier depending on the usage history of the sub-battery 7 instead of giving reward points.

Next, effects achieved by the so configured mobile supply system 1 will be described. This configuration gives reward points to a user based on the usage history of the user's sub-battery 7, which allows user to be motivated and incentivized to own their sub-batteries 7. In this particular embodiment, the system gives reward points to a user who has used the sub-battery 7 for purposes other than movement of a mobile object, which encourages the use of the sub-battery 7 for purposes other than electric vehicles, expanding the scope of the user's use of the sub-battery 7.

### Seventh Embodiment

The mobile supply system 1 according to a seventh embodiment is the same as the first embodiment except that, in the system of this embodiment, the battery control device 47 is configured to acquire a usage history of the sub-battery 7, and the management server 10 gives reward points to a user based on the user's usage history. Thus, the description of the same features as the first embodiment will not be repeated here.

The battery control device 47 is configured to be connected to the mobile object management device 35 when the sub-battery 7 is attached to the sub-holder 36.

When detecting being connected to the mobile object management device 35, the battery control device 47 determines that the sub-battery 7 is being used for the movement or power-assistance in the movement of the electric-powered mobile object 2, and counts connection time.

The battery control device 47 transmits a usage report signal including the connection time, to the terminal 8 via wireless communications each time the connection with the mobile object management device 35 is disconnected. Upon receiving the usage report signal, the terminal 8 transmits to the management server 10. When receiving the usage report signal, the management server 10 gives reward points to the corresponding user of the sub-battery 7 each time the management server receives the usage report signal. changes. In other cases, the management server 10 may make the user's available time for reservation start earlier depending on the usage time for the movement or power-assistance in the movement of the electric-powered mobile object instead of giving reward points.

Next, effects achieved by the so configured mobile supply system 1 will be described. This configuration gives reward points to a user who has used the sub-battery 7 for purposes of movement of a mobile object, which encourages the use of the sub-battery 7.

### Eighth Embodiment

The mobile supply system 1 according to an eighth embodiment is the same as the fourth embodiment, in which the available time period is set in the reservation information entry screen 82, except that the management server 10, not the terminal 8, determines the available time period. Thus, the description of the same features as the fourth embodiment will not be repeated here.

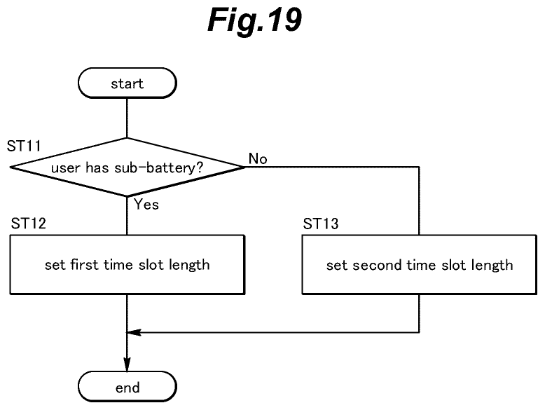

After the terminal 8 displays the reservation start screen 74 (FIG. 7), when a requesting user (i.e., a user who has made a reservation for use of the service) touches the reservation start button 73, the terminal 8 transmits, to the management server 10, requesting user's ID information including the user ID of the requesting user and a password. Upon receiving the user ID of the requesting user, the management server 10 performs a setting operation for setting the available time period for reservation of use of the electric-powered mobile object 2. Details of the setting operation will be described below, with reference to FIG. 19.

In the first step ST11 of the setting operation, the management server 10 acquires the user ID from the requesting user's ID information. Then, the management server 10 refers to the user's DB to acquire information (also referred to as “battery possession information”) on the requesting user' possession status of a sub-battery 7 (i.e., whether or not the requesting user has a sub-battery 7). When the requesting user has a sub-battery 7, the management server 10 performs step ST12, otherwise performs step ST13.

In step ST12, the management server 10 sets the available time period as a time period from a time of receiving the requesting user's ID information to a time that is a predetermined time (“time slot length”) ahead of the time of receiving. In this step, the management server 10 sets the time slot length to a first time slot length (e.g., 7 hours). Upon completion of the setting of the available time period, the management server 10 transmits a signal including the available time period to the terminal 8.

In step ST13, the management server 10 sets the available time period as a time period from a time of receiving the requesting user's ID information to a time that is the time slot length ahead of the time of receiving. In this step, the management server 10 sets the time slot length to a second time slot length (e.g., 3 hours). The second time slot length is shorter than the first time slot length. Upon completion of the setting of the available time period, the management server 10 transmits a signal including the available time period to the terminal 8.

When receiving the signal including the available time period, the terminal 8 places a restriction on entry in the entry field 83 shown in FIG. 9, such that a user is only allowed to enter a request for use of the service (a reservation for use) within the available time period. Specifically, as in the fourth embodiment, the terminal 8 may form the entry field 83 with a pull-down menu 83A that provides a list of options for a time of use, all of which fall within an available time period (a time period from a time of receiving the requesting user's ID to a time that is a certain time-slot length ahead of the time of receiving) as shown in FIG. 18(A), or when a time of use outside the available time period is entered, the terminal 8 may generate and display a warning screen 82A with a popup 83C indicating that the entered time of use is outside the available time period, on the touch panel 55 as shown in FIG. 18(B).

Next, effects achieved by the so configured mobile supply system 1, in particular, the management server 10, will be described. In this configuration, based on the battery possession information, the management server 10 sets the available time period, within which the user is allowed to enter a request for use of an electric-powered mobile object 2, and transmits a signal including the available time period to the terminal 8. The terminal 8 allows a user to enter a request for use of the service only within the available time period.

As a result, users having their sub-batteries 7 are allowed to make reservations a longer time ahead of the time of making the reservation compared to users having no sub-batteries 7. In other words, users having their sub-batteries 7 are allowed to reserve use of an electric-powered mobile object 2 earlier than users having no sub-batteries 7.

In this way, the available time period, in which users are allowed to request use of the service, for users having their sub-batteries 7 can be made different from that for users having no sub-batteries 7. Thus, this configuration can give an advantage to users having their sub-batteries 7 over users having no sub-batteries 7, thereby encouraging the use of sub-batteries 7.

The management server 10 may determine the time slot length (first time slot length, or second time slot length) based on whether or not a user has a sub-battery 7, and transmits only the determined time slot length to the terminal 8. In this case, upon receiving the time slot length, the terminal 8 may determine, based on the current time and the time slot length, the available time period, in which users are allowed to enter a request for use of the service in the entry field 83 shown in FIG. 9.

### Ninth Embodiment

The mobile supply system 1 according to a ninth embodiment is the same as the first embodiment except the operations to extract available mobile objects (first and second available mobile objects) performed by the management server 10 (step ST5). Thus, the description of the same features as the first embodiment will not be repeated here, and only the operations of step ST5 of the ninth embodiment will be described.

In step ST5, the processor 60 of the management server 10 first transmits a charging rate request signal to the terminal 8 requesting information on the charging rate of the sub-battery 7. Upon receiving the charging rate request signal, the terminal 8 acquires the charging rate from (or calculates the charging rate based on the amount of charge of) the sub-battery 7 owned (carried) by a corresponding user. The terminal 8 then transmits information including the charging rate of the sub-battery 7 (hereafter referred to as “battery charging rate information”) to the management server 10.

When acquiring the battery charging rate information, the processor 60 of the management server 10 extracts the first and second available mobile objects based on the charging rate of the sub-battery 7.

As in the first embodiment, the processor 60 of the management server 10 extracts, from among the available mobile objects, an available mobile object where the remaining battery level of the main battery 14 therein is equal to or greater than a first threshold value as a first available mobile object, and also extracts an available mobile object where the remaining battery level of the main battery 14 therein is equal to or greater than a first threshold value as a second available mobile object. (ST5). In this embodiment, the management server 10 sets the first and second threshold values based on the charging rate of the sub-battery 7, respectively.

In this case, the processor 60 of the management server 10 preferably determines the first and second threshold values such that the first and second threshold values decreases as the charging rate of the sub-battery 7 increases. Also, the processor 60 of the management server 10 preferably determines the first and second threshold values such that the second threshold value is lower than the first threshold value under the same charging rate of the sub-battery 7.

Upon completion of the extraction, the management server 10 transmits extracted information to the terminal 8 in the same manner as the first embodiment, the extracted information including a result of the determination as to whether the requesting user has a sub-battery 7, information on each of the first available mobile objects (i.e., the mobile object ID, the station ID of the station 5 in which the first available mobile object is placed, and the remaining battery level), information on each of the second available mobile object (i.e., the mobile object ID, the station ID of the station 5 in which the second available mobile object is placed, and the remaining battery level) (ST6).

Next, effects achieved by the so configured mobile supply system 1, in particular, the management server 10, will be described. In this configuration, the processor 60 of the management server 10 acquires the charging rate of the sub-battery 7 that is owned by the user and can supply power to the electric-powered mobile object 2, and then extracts the electric-powered mobile objects 2 (first available mobile object and second available mobile object) based on the acquired charging rate. The terminal 8 then presents the extracted electric-powered mobile objects 2 to the user and receives the user's selection of the electric-powered mobile object 2 (FIGS. 12(A) to 12(C)).

In this way, the system extracts electric-powered mobile objects 2 based on the charging rate of the sub-battery 7, and presents the extracted electric-powered mobile objects 2 to the user. This means that the scope of electric-powered mobile objects 2 to be presented to a user having a sub-battery 7 with a higher charging rate can be made different from that to be presented to a user having a sub-battery 7 with a lower charging rate.

This configuration also allows for setting a manner of making an extraction such that more electric-powered mobile objects 2 are presented as the charging rate increases, thereby encouraging users to recharge their sub-batteries 7.

### Tenth Embodiment

The mobile supply system 1 according to a tenth embodiment is the same as the ninth embodiment except that, in the system of this embodiment, the processor 60 of the management server 10 acquires information including the amount of charge of the sub-battery 7 from the terminal 8, instead of acquiring information including the charging rate of the sub-battery 7, and extracts electric-powered mobile objects 2 based on the amount of charge of the acquired sub-battery 7. Thus, the description of the same features as the ninth embodiment will not be repeated here.

As in the ninth embodiment, the processor 60 of the management server 10 sets the first and second threshold values based on the amount of charge of the sub-battery 7. The processor 60 of the management server 10 preferably determines the first and second threshold values such that the first and second threshold values decrease as the amount of charge of the sub-battery 7 increases. Also, the processor 60 of the management server 10 preferably determines the first and second threshold values such that the second threshold value is lower than the first threshold value under the same amount of charge of the sub-battery 7. As used herein, the term “amount of charge” corresponds to the amount of power that the sub-battery 7 can supply to the electric-powered mobile object 2.

Next, effects achieved by the so configured mobile supply system 1, in particular, the management server 10, will be described. In this configuration, the processor 60 of the management server 10 acquires the amount of charge of the sub-battery 7 that is owned by the user and can supply power to the electric-powered mobile object 2, and then extracts the electric-powered mobile objects 2 (first available mobile object and second available mobile object) based on the acquired amount of charge. The terminal 8 then presents the extracted electric-powered mobile objects 2 to the user and receives the user's selection of the electric-powered mobile object 2 (FIGS. 12(A) to 12(C)).

In this way, the system extracts electric-powered mobile objects 2 based on the amount of charge of the sub-battery 7, and presents the extracted electric-powered mobile objects 2 to the user. This means that the scope of electric-powered mobile objects 2 to be presented to a user having a sub-battery 7 with a higher amount of charge can be made different from that to be presented to a user having a sub-battery 7 with a lower amount of charge. This configuration also allows for setting a manner of making an extraction such that more electric-powered mobile objects 2 are presented as the amount of charge increases, thereby encouraging users to recharge their sub-batteries 7.

### Eleventh Embodiment

The mobile supply system 1 according to an eleventh embodiment is the same as the first embodiment except for the following points: (i) the operations to extract available mobile objects (first and second first available mobile objects) performed by the management server 10 (step ST5) is different from the first embodiment; and (ii) the battery control device 47 is configured to detect that it is connected to the mobile object management device 35 as in the seventh embodiment and acquire historical data of usage of the sub-battery 7 to supply power from the battery cells 45 to the electric-powered mobile object 2 (hereafter referred to as “power-supply historical data”), and the sub-battery 7 is configured to record and store the acquired power supply historical data in the memory 50. Thus, the description of the same features as the first embodiment will not be repeated here.

In step ST5, the processor 60 of the management server 10 first transmits a power-supply amount request signal to the terminal 8 requesting information on the amount of power supply from the sub-battery 7. Upon receiving the power-supply amount request signal, the terminal 8 acquires power-supply historical data from the sub-battery 7 owned (carried) by a corresponding user. Based on the power-supply historical data, the terminal 8 calculates the amount of power that the sub-battery 7 has supplied to the electric-powered mobile object 2 so far (hereinafter referred to as “supplied power amount”). The terminal 8 then transmits information including the supplied power amount from the sub-battery 7 (hereafter referred to as “supplied power amount information”) to the management server 10.

Upon acquiring the supplied power amount information, the processor 60 of the management server 10 extracts the first and second available mobile objects based on the supplied power amount of the sub-battery 7.

As in the first embodiment, the processor 60 of the management server 10 extracts, from among the available mobile objects, an available mobile object where the remaining battery level of the main battery 14 therein is equal to or greater than a first threshold value as a first available mobile object, and also extracts an available mobile object where the remaining battery level of the main battery 14 therein is equal to or greater than a first threshold value as a second available mobile object. (ST5). In this embodiment, the management server 10 sets the first and second threshold values based on the supplied power amount of the sub-battery 7, respectively.

In this case, the processor 60 of the management server 10 preferably determines the first and second threshold values such that the first and second threshold values decreases as the supplied power amount of the sub-battery 7 increases. Also, the processor 60 of the management server 10 preferably sets the first and second threshold values such that the second threshold value is lower than the first threshold value under the same supplied power amount of the sub-battery 7.

Upon completion of the extraction, the management server 10 transmits extracted information to the terminal 8 in the same manner as the first embodiment, the extracted information including a result of the determination as to whether the requesting user has a sub-battery 7, information on each of the first available mobile objects (i.e., the mobile object ID, the station ID of the station 5 in which the first available mobile object is placed, and the remaining battery level), information on each of the second available mobile object (i.e., the mobile object ID, the station ID of the station 5 in which the second available mobile object is placed, and the remaining battery level) (ST6).

Next, effects achieved by the so configured mobile supply system 1, in particular, the management server 10, will be described. In this configuration, the processor 60 of the management server 10 acquires the supplied power amount of the sub-battery 7 that is owned by the user and can supply power to the electric-powered mobile object 2, and then extracts the electric-powered mobile objects 2 (first available mobile object and second available mobile object) based on the acquired supplied power amount. The terminal 8 then presents the extracted electric-powered mobile objects 2 to the user and receives the user's selection of the electric-powered mobile object 2 (FIGS. 12(A) to 12(C)).

In this way, the system extracts electric-powered mobile objects 2 based on the supplied power amount of the sub-battery 7, and presents the extracted electric-powered mobile objects 2 to the user. This means that the scope of electric-powered mobile objects 2 to be presented to a user having a sub-battery 7 with a higher supplied power amount can be made different from that to be presented to a user having a sub-battery 7 with a lower supplied power amount. This configuration also allows for setting a manner of making an extraction such that more electric-powered mobile objects 2 are presented as the supplied power amount increases, thereby encouraging users to recharge their sub-batteries 7.

Specific embodiments of the present invention have been described herein for illustrative purposes. However, the present invention is not limited to those specific embodiments, and various modifications may be made to the embodiments.

In the above-described embodiments, the system is configured such that a user enters a planned travel distance. However, in other embodiments, the system may be configured such that the management server 10 is configured to estimate a planned travel distance based on the user's usage status and other information.

In the above-described embodiments, the system is configured such that a sub-battery 7 and a terminal 8 are separate elements. However, in other embodiments, the sub-battery 7 and the terminal 8 may be configured as one unit, or the sub-battery 7 may be configured to substantially function as the terminal 8.

In the sixth and seventh embodiments, the system is configured to give reward points to a subject user, thereby allowing the user to be incentivized to own their sub-batteries 7. However, the manner of providing an incentive to a user is not limited to giving reward points. The system may be configured to provide an incentive to a user who has used the sub-battery 7 for purposes other than movement of an electric-powered mobile object 2, or a user who has used the sub-battery 7 for purposes of movement of an electric-powered mobile object 2, for example, by lowering the second threshold to broaden the scope of selectable electric-powered mobile objects 2. In some cases, the system may be configured to provide an incentive to a subject user by changing the available time period to start earlier, as in the fourth embodiment. In other cases, the system may be configured to provide an incentive to a subject user by broadening the scope of selectable electric-powered mobile objects 2, as in the fifth embodiment. In addition, either the terminal 8 or the management server 10 may provide an incentive, or both the terminal 8 and management server 10 may cooperatively operate to provide an incentive.

In the above-described embodiments, as the communication distance between the terminal 8 and the sub-ECU 38 is limited to within a range from a few meters to a few dozen meters, the system is configured to cause the light-emitting devices 39 of an electric-powered mobile object 2 located within this distance range from the terminal 8 to emit light. However, the system may be configured to cause the light-emitting devices 39 of an electric-powered mobile object 2 within a few tens of meters of the terminal 8 to emit light by adopting other configurations, instead of limiting the communication distance. For example, the system may be configured such that both the terminal 8 and the sub-ECU 38 are configured to be positioned by GNSS (Global Navigation Satellite System), allowing the sub-ECU 38 to acquire the position of the terminal 8 in order to determine whether the distance to the terminal 8 is within a predetermined communication distance, and that when determining that the distance to the terminal 8 is within the predetermined communication distance, the sub-ECU 38 allows the light-emitting devices 39 to emit light.

In the above-described embodiments, the system is configured such that the processor 40 of the sub-ECU 38 sets and changes the characteristics or manner of light emission from the light-emitting devices 39 based on the remaining battery level of the main battery 14 or on the sum of the remaining battery levels of the main battery 14 and the sub-battery 7. However, in other embodiments, the system may be configured such that the processor 40 of the sub-ECU 38 calculates a possible travel distance of the electric-powered mobile object 2 from the remaining battery level of the main battery 14 or from the sum of the remaining battery levels of the main battery 14 and the sub-battery 7, and then sets and change the characteristics or manner of light emission from the light-emitting devices 39 based on the possible travel distance. The processor 40 of the sub-ECU 38 may acquire the possible travel distance by multiplying the remaining battery level (or the sum of the remaining battery levels) by a coefficient (hereinafter referred to as “conversion coefficient”) set for each electric-powered mobile object 2, and the conversion factor may be determined based on the type of the electric-powered mobile object 2 or the degree of deterioration of the electric-powered mobile object 2. In addition, the conversion factor may be included in the mobile object DB. When the conversion factor is based on the degree of deterioration of the electric-powered mobile object 2, the conversion factor may be set by an administrator at the time of maintenance of the electric-powered mobile object 2.

In the above-described embodiments, the system is configured such that a station server 9 is provided at each of the stations 5. However, a station server 9 may not be provided at each of the stations 5. For example, the main ECU 29 or sub-ECU 38 in the electric-powered mobile object 2 may be configured to communicate directly to the management server 10 via the network 11.

In the above-described embodiments, the system is configured such that, in response to the wireless signal transmitted from the terminal 8, the light-emitting devices 39 on the electric-powered mobile object 2 emits light to notify the user of the location of the reserved electric-powered mobile object 2. However, the emission of light may not be caused by receiving the wireless signal. In other embodiments, the system may be configured such that a notification device such as a light-emitting device 51 is provided in a sub-battery 7 carried by a user, and that, when the distance between the electric-powered mobile object 2 (in particular, the main ECU 29 or the sub-ECU 38) and the sub-battery 7 is below a predetermined distance, the notification device in the sub-battery 7 provides a notification signal (More specifically, the light-emitting device(s) 51 of the sub-battery 7 emits light.)

In the above-described embodiments, the system is configured to allow users having no sub-batteries 7 to select any of electric-powered mobile objects 2 with their main batteries 14 having the remaining battery levels that are above the first threshold, while allowing users having their sub-batteries 7 to select any of electric-powered mobile objects 2 with their main batteries 14 having the remaining battery levels that are above the second threshold. However, the bases for the determination of the different scopes of selectable electric-powered mobile objects 2 is not limited to different threshold values. For example, the system may be configured such that, when the management server 10 (or the terminal 8) receives a request for use of the service from a user having a sub-battery 7, the system presents selectable electric-powered mobile objects 2 including those with their main batteries 14 having lower remaining battery levels than those of selectable electric-powered mobile objects 2 that are presented to a requesting user having no sub-battery 7.

In the sixth and seventh embodiments, the system is configured to use usage time as the user's usage history. However, a usable usage history is not limited to usage time. For example, the system may be configured to provide an incentive to a user based on the amount of power that the user's sub-battery 7 has supplied (i.e., supplied power amount). Examples of the manners of providing an incentive to a user include giving reward point, and changing the available time period to start earlier, and other methods.

In the above-described embodiments, a user's smartphone is used as the terminal 8. However, devices that can be used as the terminal 8 are not limited to smartphones. The terminal 8 may be a device rented by the operator of the mobile supply system 1 (or the service provider).

### Glossary

1 mobile supply system
2 electric-powered mobile object (mobile object)
5 station
7 sub-battery
8 terminal
10 management server
14 main battery
15 driving source
36 sub-battery holder (battery holder)
38 sub-ECU (control device)
39 light-emitting device (an example of the notification device)
43 speaker (another example of the notification device)

1. A battery holder for attaching a battery to a mobile object, the battery holder comprising:
a notification device configured such that, when a wireless signal corresponding to the notification device is transmitted, the notification device provides a notification signal to outside of the battery holder.

2. The battery holder as claimed in claim 1, wherein the battery is capable of transmitting the wireless signal.

3. The battery holder as claimed in claim 2, further comprising a control device configured to receive the wireless signal, cause the notification device to operate based on the received wireless signal, and store an ID number of the mobile object, and
wherein the control device compares the stored ID number with a received ID number contained in the received wireless signal, and when the stored ID number corresponds to the received ID number, the control device causes the notification device to operate.

4. A mobile supply system for providing at least one of mobile objects placed at a station to a user, the mobile supply system comprising:
a notification device provided in each of the mobile objects and capable of providing a notification signal to outside of the mobile object in which the notification device is provided:
a terminal held by the user and capable of transmitting a wireless signal; and
a control device provided in the mobile object in which the notification device is provided and configured such that, when receiving the wireless signal, the control device causes the notification device in the same mobile object to provide the notification signal to the outside.

5. The mobile supply system as claimed in claim 4, wherein the terminal transmits the wireless signal which includes ID information for identifying one of the mobile objects, and
wherein, when receiving the wireless signal, the control device determines whether or not the ID information in the received wireless signal corresponds to the mobile object in which the control device is provided, and
wherein, when determining that the ID information corresponds to the mobile object, the control device causes the notification device in the same mobile object to provide the notification signal to the outside.

6. The mobile supply system as claimed in claim 4, further comprising a management server configured to acquire reservation confirmation information that identifies a selected mobile object selected by the user from the mobile objects and transmits the reservation confirmation information to the terminal,
wherein the terminal transmits the wireless signal with the reservation confirmation information included therein,
wherein, when receiving the wireless signal from the terminal, the control device determines whether or not the mobile object in which the control device is provided is the selected mobile object, and
wherein, when determining that the mobile object in which the control device is provided is the selected mobile object, the control device causes the notification device in the selected mobile object to provide the notification signal to the outside.

7. The mobile supply system as claimed in claim 4, wherein the notification device includes a light-emitting device capable of emitting light to the outside of the mobile object, and
wherein the notification device causes the light-emitting device to emit light, thereby providing the notification signal to the outside.

8. The mobile supply system as claimed in claim 4, wherein the notification device includes a speaker capable of emitting a sound to the outside of the mobile object, and
wherein the notification device causes the speaker to emit the sound, thereby providing the notification signal to the outside.

9. The mobile supply system as claimed in claim 4, wherein the mobile object includes a body, a driving source that causes movement of the body or assists the movement of the body, and a main battery that supplies power to the driving source, and
wherein, when receiving the wireless signal from the terminal, the control device acquires a remaining battery level of the main battery and causes the notification device to provide the notification signal to the outside according to the remaining battery level of the main battery.

10. The mobile supply system as claimed in claim 9, wherein the notification device includes a plurality of light-emitting devices capable of emitting light to thereby provide the notification signal to the outside of the mobile object, and
wherein the control device causes the notification device to change a number of light-emitting devices which are included in the plurality of light-emitting devices and emit light, thereby providing the notification signal to the outside according to the remaining battery level of the main battery.

11. The mobile supply system as claimed in claim 9, wherein the notification device includes a light-emitting device capable of emitting light to the outside of the mobile object, and changing a color of the light emitted, and
wherein the control device causes the notification device to change the color of the light emitted by the light-emitting device, thereby providing the notification signal to the outside according to the remaining battery level of the main battery.

12. The mobile supply system as claimed in claim 4, wherein the mobile object includes a body, a driving source that causes movement of the body or assists the movement of the body, and a main battery that supplies power to the driving source,
wherein the terminal includes a sub-battery capable of supplying power to the driving source, and
wherein, when receiving the wireless signal from the terminal, the control device acquires a remaining battery level of the main battery and a remaining battery level of the sub-battery, and causes the notification device to provide the notification signal to the outside according to a sum of the remaining battery level of the main battery and the remaining battery level of the sub-battery.

13. The mobile supply system as claimed in claim 12, wherein the notification device includes a plurality of light-emitting devices capable of emitting light to thereby provide the notification signal to the outside of the mobile object, and
wherein the control device causes the notification device to change a number of light-emitting devices which are included in the plurality of light-emitting devices and emit light, thereby providing the notification signal to the outside according to the sum of the remaining battery level of the main battery and the remaining battery level of the sub-battery.

14. The mobile supply system as claimed in claim 12, wherein the notification device includes a light-emitting device capable of emitting light to the outside of the mobile object, and changing a color of the light emitted, and
wherein the control device causes the notification device to change the color of the light emitted by the light-emitting device, thereby providing the notification signal to the outside according to the sum of the remaining battery level of the main battery and the remaining battery level of the sub-battery.

15. The mobile supply system as claimed in claim 12, further comprising a management server configured to acquire a planned travel distance, which is a distance to be traveled by the mobile object and planned by the user,
wherein the management server acquires, based on the planned travel distance, a minimum battery level required for the movement or power-assistance in the movement of the mobile object for the planned travel distance, and notifies the control device of the minimum battery level, and
wherein, when the sum of the remaining battery level of the main battery and the remaining battery level of the sub-battery is greater than or equal to the acquired minimum battery level, the control device causes the notification device to provide the notification signal to the outside.

16. A mobile supply method for providing at least one of mobile objects placed at a station to a user, wherein a notification device is provided in each of the mobile objects, and capable of providing a notification signal to outside of the mobile object in which the notification device is provided, the method comprising the step of,
upon receiving a wireless signal transmitted from a terminal held by the user, causing the notification device to operate, thereby providing the notification signal to notify the user of a location of the mobile object to be provided to the user.
